(19) United States
(12) Patent Application Publication
(10) Pub. No.: US 2021/0274203 A1
(43) Pub. Date: Sep. 2, 2021

(54) SYSTEMS AND METHODS FOR RGB VIDEO CODING ENHANCEMENT

(71) Applicant: VID SCALE, INC., Wilmington, DE (US)

(72) Inventors: Xiaoyu Xiu, San Diego, CA (US); Yuwen He, San Diego (UD); Chia-Ming Tsai, San Diego, CA (US); Yan Ye, San Diego, CA (US)

(73) Assignee: VID SCALE, INC., Wilmington, DE (US)

(21) Appl. No.: 17/211,498

(22) Filed: Mar. 24, 2021

Related U.S. Application Data
(63) Continuation of application No. 14/658,179, filed on Mar. 14, 2015.
(60) Provisional application No. 62/040,317, filed on Aug. 21, 2014.
(60) Provisional application No. 61/994,071, filed on May 15, 2014.
(60) Provisional application No. 61/953,185, filed on Mar. 14, 2014.

(51) Int. Cl. H04N 19/44; H04N 19/46; H04N 19/174; H04N 19/176; H04N 19/12

(52) U.S. Cl. CPC H04N 19/44; H04N 19/46; H04N 19/12; H04N 19/176; H04N 19/174

(57) ABSTRACT

Systems, methods, and devices are disclosed for performing adaptive residue color space conversion. A video bitstream may be received and a first flag may be determined based on the video bitstream. A residual may also be generated based on the video bitstream. The residual may be converted from a first color space to a second color space in response to the first flag.

### CROSS-REFERENCE TO RELATED APPLICATIONS

This application claims priority to U.S. Provisional Patent Application Ser. No. 61/953,185, filed Mar. 14, 2014, U.S. Provisional Patent Application Ser. No. 61/994,071, filed May 15, 2014, and U.S. Provisional Patent Application Ser. No. 62/040,317, filed Aug. 21, 2014, each of which is entitled “RGB VIDEO CODING ENHANCEMENT,” and each of which are incorporated herein by reference in their entireties.

### BACKGROUND

Screen content sharing applications have become more popular as the capabilities of devices and networks have improved. Examples of popular screen content sharing applications include remote desktop applications, video conferencing applications, and mobile media presentation applications. Screen content may include numerous video and/or image elements that have one or more major colors and/or sharp edges. Such images and video elements may include relatively sharp curves and/or text inside within such elements. While various video compression means and methods may be used to encode screen content and/or to transmit such content to a receiver, such methods and means may not fully characterize the feature(s) of the screen content. Such a lack of characterization may lead to reduced compression performance in the reconstructed image or video content. In such implementations, a reconstructed image or video content may be negatively impacted by image or video quality issues. For example, such curves and/or text may be blurred, fuzzy, or otherwise difficult to recognize within the screen content.

### SUMMARY

Systems, methods, and devices are disclosed for encoding and decoding video content. In an embodiment, systems and methods may be implemented to perform adaptive residue color space conversion. A video bitstream may be received and a first flag may be determined based on the video bitstream. A residual may also be generated based on the video bitstream. The residual may be converted from a first color space to a second color space in response to the first flag.

In an embodiment, determining the first flag may include receiving the first flag at a coding unit level. The first flag may be received only when a second flag at the coding unit level indicates there is at least one residual with a non-zero value in the coding unit. Converting the residual from the first color space to the second color space may be performed by applying a color space conversion matrix. This color space conversion matrix may correspond to an irreversible YCgCo to RGB conversion matrix that may be applied in lossy coding. In another embodiment, the color space conversion matrix may correspond to a reversible YCgCo to RGB conversion matrix that may be applied in lossless coding. Converting a residual from the first color space to the second color space may include applying a matrix of scale factors, and, where the color space conversion matrix is not normalized, each row of the matrix of scale factors may include scale factors that correspond to a norm of a corresponding row of the non-normalized color space conversion matrix. The color space conversion matrix may include at least one fixed-point precision coefficient. A second flag based on the video bitstream may be signaled at a sequence level, a picture level, or a slice level, and the second flag may indicate whether a process of converting the residual from the first color space to the second color space is enabled for the sequence level, picture level, or slice level, respectively.

In an embodiment, a residual of a coding unit may be encoded in a first color space. A best mode of encoding such a residual may be determined based on the costs of encoding the residual in the available color spaces. A flag may be determined based on the determined best mode and may be included in an output bitstream. These and other aspects of the subject matter disclosed are set forth below.

### BRIEF DESCRIPTION OF THE DRAWINGS

FIG. 1 is a block diagram illustrating an exemplary screen content sharing system according to an embodiment.

FIG. 2 is a block diagram illustrating an exemplary video encoding system according to an embodiment.

FIG. 3 is a block diagram illustrating an exemplary video decoding system according to an embodiment.

FIG. 4 illustrates exemplary prediction unit modes according to an embodiment.

FIG. 5 illustrates an exemplary color image according to an embodiment.

FIG. 6 illustrates an exemplary method of implementing an embodiment of the disclosed subject matter.

FIG. 7 illustrates another exemplary method of implementing an embodiment of the disclosed subject matter.

FIG. 8 is a block diagram illustrating an exemplary video encoding system according to an embodiment.

FIG. 9 is a block diagram illustrating an exemplary video decoding system according to an embodiment.

FIG. 10 is a block diagram illustrating exemplary subdivisions of a prediction unit into transform units according to an embodiment.

FIG. 11A is a system diagram of an example communications system in which the disclosed subject matter may be implemented.

FIG. 11B is a system diagram of an example wireless transmit/receive unit (WTRU) that may be used within the communications system illustrated in FIG. 11A.

FIG. 11C is a system diagram of an example radio access network and an example core network that may be used within the communications system illustrated in FIG. 11A.

FIG. 11D is a system diagram of another example radio access network and an example core network that may be used within the communications system illustrated in FIG. 11A.

FIG. 11E is a system diagram of another example radio access network and an example core network that may be used within the communications system illustrated in FIG. 11A.

### DETAILED DESCRIPTION

A detailed description of illustrative examples will now be described with reference to the various figures. Although this description provides a detailed example of possible implementations, it should be noted that the details are intended to be exemplary only and in no way limit the scope of the application.

Screen content compression methods are becoming important as more people share device content for use in, e.g., media presentations and remote desktop applications. Display capabilities of mobile devices have increased, in some embodiments, to high definition or ultra-high definition resolutions. Video coding tools, such as block coding modes and transform, may not be optimized for higher definition screen content encoding. Such tools may increase the bandwidth that may be used for transmitting screen content in content sharing applications.

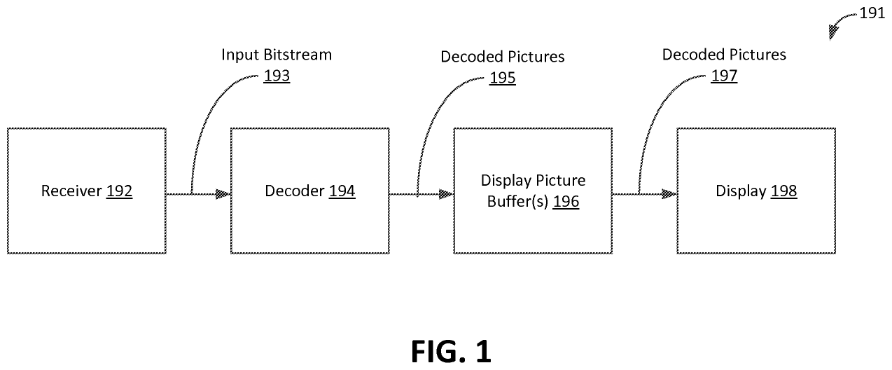

FIG. 1 illustrates a block diagram of exemplary screen content sharing system 191. System 191 may include receiver 192, decoder 194, and display 198 (that may also be referred to as a “renderer”). Receiver 192 may provide input bitstream 193 to decoder 194, which may decode the bitstream to generate decoded pictures 195 that may be provided to one or more display picture buffers 196. Display picture buffers 196 may provide decoded pictures 197 to display 198 for presentation on a device's display(s).

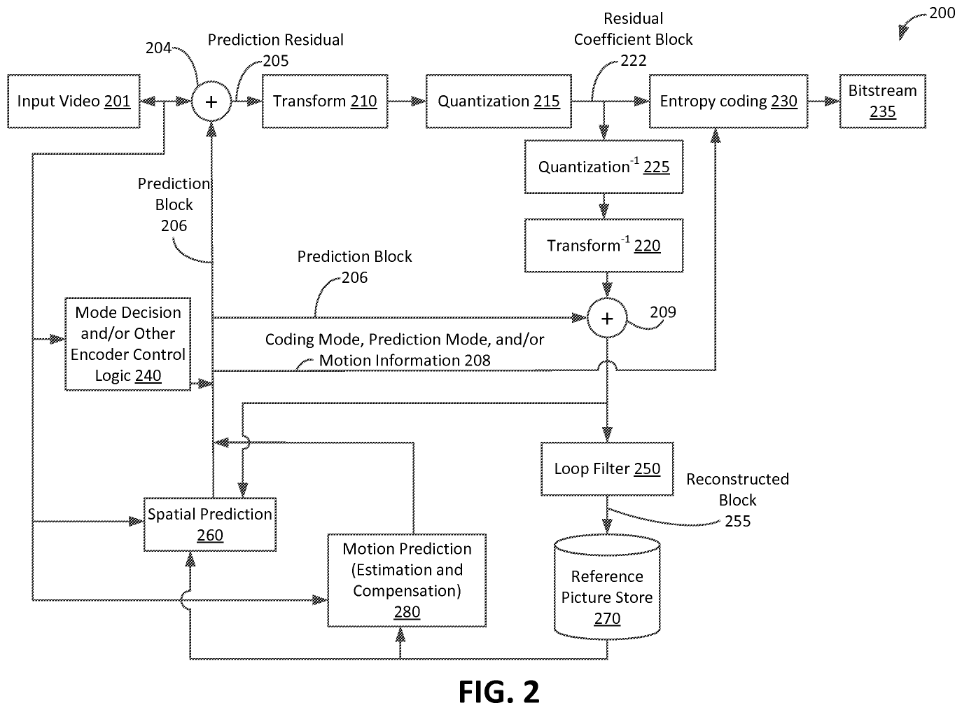

FIG. 2 illustrates a block diagram of block-based single layer video encoder 200 that may, for example, be implemented to provide a bitstream to receiver 192 of system 191 of FIG. 1. As shown in FIG. 2, encoder 200 may use techniques such as spatial prediction (that may also be referred to as “intra-prediction”) and temporal prediction (that may also be referred to as “inter-prediction” or “motion-compensated-prediction”) to predict input video signal 201 in an effort to increase compression efficiency. Encoder 200 may include mode decision and/or other encoder control logic 240 that may determine a form of prediction. Such a determination may be based, at least in part, on criteria such as rate-based criteria, distortion-based criteria, and/or a combination thereof. Encoder 200 may provide one or more prediction blocks 206 to element 204, which may generate and provide prediction residual 205 (that may be a difference signal between an input signal and a prediction signal) to transform element 210. Encoder 200 may transform prediction residual 205 at transform element 210 and quantize prediction residual 205 at quantization element 215. The quantized residual, together with the mode information (e.g., intra- or inter-prediction) and prediction information (motion vectors, reference picture indexes, intra prediction modes, etc.) may be provided to entropy coding element 230 as residual coefficient block 222. Entropy coding element 230 may compress the quantized residual and provide it with output video bitstream 235. Entropy coding element 230 may also, or instead, use coding mode, prediction mode, and/or motion information 208 in generating output video bitstream 235.

In an embodiment, encoder 200 may also, or instead, generate a reconstructed video signal by applying inverse quantization to residual coefficient block 222 at inverse quantization element 225 and inverse transform at inverse transform element 220 to generate a reconstructed residual that may be added back to prediction signal 206 at element 209. The resulting reconstructed video signal may, in some embodiments, be processed using a loop filter process implemented at loop filter element 250 (e.g., by using one or more of a deblocking filter, sample adaptive offsets, and/or adaptive loop filters). The resulting reconstructed video signal, in some embodiments in the form of reconstructed block 255, may be stored at reference picture store 270, where it may be used to predict future video signals, for example by motion prediction (estimation and compensation) element 280 and/or spatial prediction element 260. Note that in some embodiments, a resulting reconstructed video signal generated by element 209 may be provided to spatial prediction element 260 without processing by an element such as loop filter element 250.

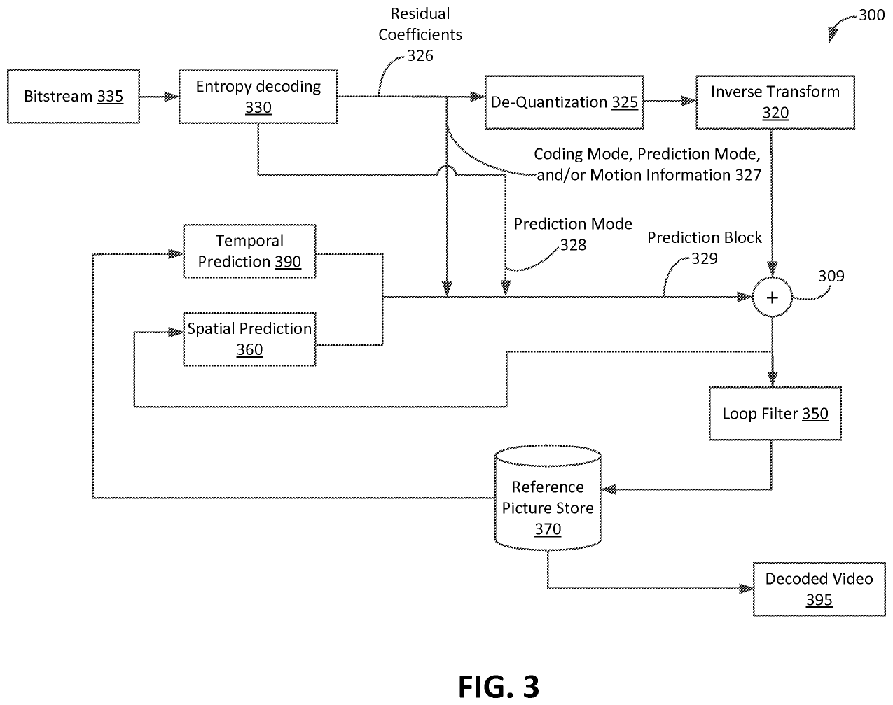

FIG. 3 illustrates a block diagram of block-based single layer decoder 300 that may receive video bitstream 335, which may be a bitstream such as bitstream 235 that may be generated by encoder 200 of FIG. 2. Decoder 300 may reconstruct bitstream 335 for display on a device. Decoder 300 may parse bitstream 335 at entropy decoder element 330 to generate residual coefficients 326. Residual coefficients 326 may be inverse quantized at de-quantization element 325 and/or may be inverse transformed at inverse transform element 320 to obtain a reconstructed residual that may be provided to element 309. Coding mode, prediction mode, and/or motion information 327 may be used to obtain a prediction signal, in some embodiments using one or both of spatial prediction information provided by spatial prediction element 360 and/or temporal prediction information provided by temporal prediction element 390. Such a prediction signal may be provided as prediction block 329. The prediction signal and the reconstructed residual may be added at element 309 to generate a reconstructed video signal that may be provided to loop filter element 350 for loop filtering and that may be stored in reference picture store 370 for use in displaying pictures and/or decoding video signals. Note that prediction mode 328 may be provided by entropy decoding element 330 to element 309 for use in generating a reconstructed video signal that may be provided to loop filter element 350 for loop filtering.

Video coding standards, such as High Efficiency Video Coding (HEVC), may reduce transmission bandwidth and/or storage. In some embodiments, HEVC implementations may operate as block-based hybrid video coding where the implemented encoder and decoder generally operate as described herein in reference to FIGS. 2 and 3. HEVC may allow the use of larger video blocks and may use quadtree partitions to signal block coding information. In such embodiments, a picture, or a slice of a picture, may be partitioned into coding tree blocks (CTBs) each having a same size (e.g., 64×64). Each CTB may be partitioned into coding units (CUs) with quadtree partitioning and each CU may be further partitioned into prediction units (PUs) and transform units (TUs), each of which may also be partitioned using quadtree partitioning.

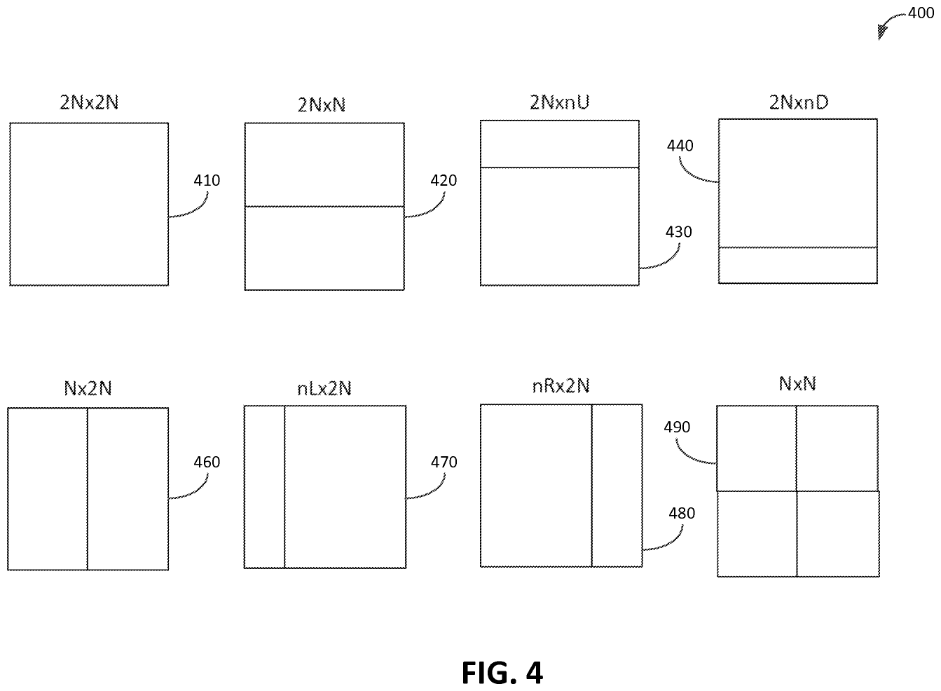

In an embodiment, for each inter-coded CU, the associated PUs may be partitioned using one of eight exemplary partition modes, examples of which are illustrated as modes 410, 420, 430, 440, 460, 470, 480, and 490 in FIG. 4. Temporal prediction may be applied in some embodiments to reconstruct inter-coded PUs. Linear filters may be applied to obtain pixel values at fractional positions. An interpolation filter used in some such embodiments may have seven or eight taps for luma and/or four taps for chroma. A deblocking filter may be used that may be content-based, such that different deblocking filter operations may be applied at each of the TU and PU boundaries depending on a number of factors, which may include one or more of a coding mode difference, a motion difference, a reference picture difference, a pixel value difference, etc. In entropy coding embodiments, a context-adaptive binary arithmetic coding (CABAC) may be used for one or more block level syntax elements. In some embodiments, a CABAC may not be used for high level parameters. Bins that may be used in CABAC coding may include a context-based coded regular bin and a by-pass coded bin that does not use context.

Screen content videos may be captured in red-green-blue (RGB) format. RGB signals may include redundancies between the three color components. While such redundancies may be less efficient in embodiments implementing video compression, the use of the RGB color space may be selected for applications where high fidelity may be desired for decoded screen content video because color space conversion (for example, from RGB encoding to YCbCr encoding) may introduce losses to the original video signal due to rounding and clipping operations that may be used to convert a color component between different spaces. In some embodiments, video compression efficiency may be improved by exploiting correlations between the three color components of color spaces. For example, a coding tool of cross-component prediction may use the residue of a G component to predict the residues of B and/or R components. The residue of a Y component in YCbCr embodiments may be used predict the residues of Cb and/or Cr components.

In an embodiment, motion-compensated prediction techniques may be used to exploit the redundancy between temporal neighboring pictures. In such embodiments, motion vectors may be supported that are as accurate as one quarter pixel for a Y component and one eighth pixel for Cb and/or Cr components. In an embodiment, a fractional sample interpolation may be used that may include separable 8-tap filters for half-pixel positions and 7-tap filters for quarter-pixel positions. Table 1 below illustrates exemplary filter coefficients for Y component fractional interpolation. Fractional interpolation of Cb and/or Cr components may be performed using similar filter coefficients, except that, in some embodiments, separable 4-tap filters may be used and a motion vector may be as accurate as one eighth of a pixel for 4:2:0 video format implementations. In 4:2:0 video format implementations, Cb and Cr components may contain less information than a Y component and 4-tap interpolation filters may reduce the complexity of fractional interpolation filtering and may not sacrifice the efficiency that may be obtained in motion compensated prediction for Cb and Cr components as compared to 8-tap interpolation filter implementations. Table 2 below illustrates exemplary filter coefficients that may be used for fractional interpolation of Cb and Cr components.

TABLE 1
Exemplary filter coefficients for Y
component fractional interpolation

| Fractional position | Filter coefficients |
|---|---|
| 0 | {0, 0, 0, 64, 0, 0, 0, 0} |
| 2/4 | {−1, 4, −10, 58, 17, −5, 1, 0} |
| 2/4 | {−1, 4, −11, 40, 40, −11, 4, −1} |
| ¾ | {0, 1, −5, 17, 58, −10, 4, −1} |

TABLE 2
Exemplary filter coefficients for Cb and
Cr component fractional interpolation

| Fractional position | Filter coefficients |
|---|---|
| 0 | {0, 64, 0, 0} |
| ⅛ | {−2, 58, 10, −2} |
| 2/8 | {−4, 54, 16, −2} |
| ⅜ | {−6, 46, 28, −4} |
| 4/8 | {−4, 36, 36, −4} |
| ⅝ | {−4, 28, 46, −6} |
| 6/8 | {−2, 16, 54, −4} |
| ⅞ | {−2, 10, 58, −2} |

In an embodiment, a video signal originally captured in RGB color format may be encoded in the RGB domain, for example if high fidelity is desired for the decoded video signal. Cross-component prediction tools may improve the efficiency of coding an RGB signal. In some embodiments, the redundancy that may exist between the three color components may not be fully exploited because, in some such embodiments, the G component may be utilized to predict the B and/or R components while the correlation between the B and R components may not be used. De-correlation of such color components may improve coding performance for RGB video coding.

Fractional interpolation filters may be used to encode an RGB video signal. Interpolation filter designs that may be focused on coding YCbCr video signals in a 4:2:0 color format may not be preferable for encoding RGB video signals. For example, B and R components of RGB video may represent more abundant color information and may possess more high frequency characteristics than the chrominance components of converted color spaces, such as Cb and Cr components in a YCbCr color space. 4-tap fractional filters that may be used for Cb and/or Cr components may not be accurate enough for motion compensated prediction of B and R components when coding RGB video. In lossless coding embodiments, reference pictures may be used for motion compensated prediction that may be mathematically the same as the original pictures associated with such reference pictures. In such embodiments, such reference pictures may contain more edges (i.e., high-frequency signals) when compared to lossy coding embodiments using the same original pictures, where high frequency information in such reference pictures may be reduced and/or distorted due to the quantization process. In such embodiments, shorter-tap interpolation filters that may preserve the higher frequency information in the original pictures may be used for B and R components.

In an embodiment, a residue color conversion method may be used to adaptively select RGB or YCgCo color space for coding residue information associated with an RGB video. Such residue color space conversion methods may be applied to either or both lossless and lossy coding without incurring excessive computational complexity overhead during the encoding and/or decoding processes. In another embodiment, interpolation filters may be adaptively selected for use in motion compensated prediction of different color components. Such methods may allow the flexibility to use different fractional interpolation filters at a sequence, picture, and/or CU levels, and may improve the efficiency of motion compensation based predictive coding.

In an embodiment, residual coding may be performed in a different color space from the original color space to remove the redundancy of the original color space. Video coding of natural content (for example, camera capture video content) may be performed in YCbCr color space instead of RGB color space because coding in the YCbCr color space may provide a more compact representation of an original video signal than coding in the RGB color space (for example, cross component correlation may be lower in the YCbCr color space than in the RGB color space) and the coding efficiency of YCbCr may be higher than that of RGB. Source video may be captured in RGB format for most cases and high fidelity of the reconstructed video may be desired.

Color space conversion is not always lossless and the output color space may have the same dynamic range as that of the input color space. For example, if RGB video is converted to ITU-R BT.709 YCbCr color space with same bit-depth, then there may be some loss due to rounding and truncation operations that may be performed during such a color space conversion. YCgCo may be a color space that may have similar characteristics to the YCbCr color space, but the conversion process between RGB and YCgCo (i.e., from RGB to YCgCo and from YCgCo to RGB) may be more computationally simple than the conversion process between RGB and YCbCr because only shifting and addition operations may be used during such a conversion. YCgCo may also support fully reversible conversion (i.e., where the derived color values after reverse conversion may be numerically identical to the original color values) by increasing the bit-depth of intermediate operations by one. This aspect may be desirable because it may be applicable to both lossy and lossless embodiments.

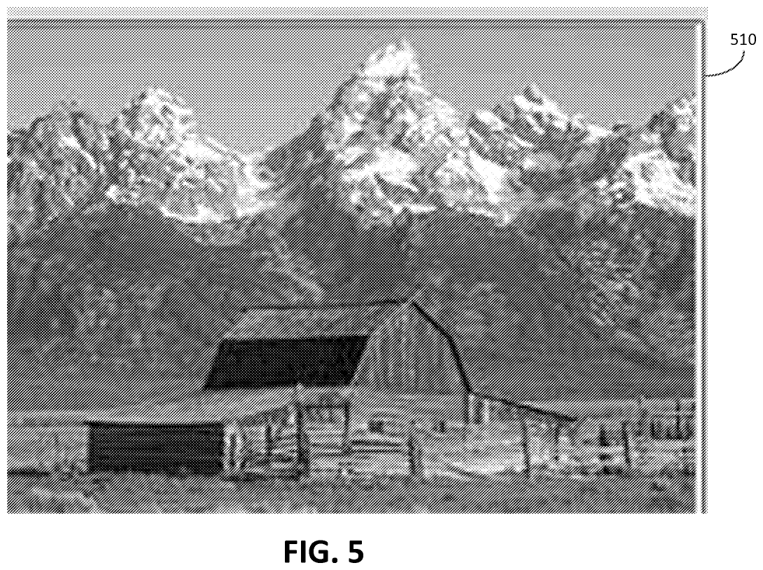

Because of coding efficiency and the ability to perform a reversible conversion provided by YCgCo color space, in an embodiment, the residue may be converted from RGB to YCgCo prior to residue coding. The determination of whether to apply the RGB to YCgCo conversion process may be adaptively performed at the sequence and/or slice and/or block level (e.g., CU level). For example, a determination may be made based on whether applying a conversion offers an improvement in a rate-distortion (RD) metric (e.g., a weighted combination of rate and distortion). FIG. 5 illustrates exemplary image 510 that may be an RGB picture. Image 510 may be decomposed into the three color components of YCgCo. In such an embodiment, both the reversible and irreversible versions of a conversion matrix may be specified for lossless coding and lossy coding, respectively. When residues are encoded in RGB domain, an encoder may treat a G component as a Y component and B and R components as Cb and Cr components, respectively. In the instant disclosure, an order of G, B, R may be used rather than an order R, G, B for representing RGB video. Note that while the embodiments described herein may be described using examples where a conversion is performed from RGB to YCgCo, one skilled in the art will recognize that conversion between RGB and other color spaces (e.g., YCbCr) may also be implemented using the disclosed embodiments. All such embodiments are contemplated as within the scope of the instant disclosure.

A reversible conversion from GBR color space to YCgCo color space may be performed using equations (1) and (2) shown below. These equations may be used for both lossy and lossless coding. Equation (1) illustrates a means, according to an embodiment, of implementing a reversible conversion from GBR color space to YCgCo:

$$( \begin{matrix}Y \\ C g \\ C o\end{matrix} ) = ( \begin{matrix}1 / 2 & 1 / 4 & 1 / 4 \\ 1 & - 1 / 2 & - 1 / 2 \\ 0 & - 1 & 1\end{matrix} ) ( \begin{matrix}G \\ B \\ R\end{matrix} ) \qquad ( 1 )$$

which may be performed using shifting without multiplication or division, since:

Co=R−B

t=B+(Co»1)

Cg=G−t

Y=t+(Cg»1).

In such an embodiment, an inverse conversion from YCgCo to GBR may be performed using equation (2):

$$( \begin{matrix}G \\ B \\ R\end{matrix} ) = ( \begin{matrix}1 & 1 / 2 & 0 \\ 1 & - 1 / 2 & - 1 / 2 \\ 1 & - 1 / 2 & 1 / 2\end{matrix} ) ( \begin{matrix}Y \\ C g \\ C o\end{matrix} ) \qquad ( 2 )$$

which may be performed with shifting, since:

t=Y−(Cg»1)

G=Cg+t

B=t−(Co»1)

R=Co+B.

In an embodiment, an irreversible conversion may be performed using equations (3) and (4) shown below. Such an irreversible conversion may be used for lossy coding and, in some embodiment, may not be used for lossless encoding. Equation (3) illustrates a means, according to an embodiment, of implementing an irreversible conversion from GBR color space to YCgCo:

$$( \begin{matrix}Y \\ C g \\ C o\end{matrix} ) = ( \begin{matrix}1 / 2 & 1 / 4 & 1 / 4 \\ 1 / 2 & - 1 / 4 & - 1 / 4 \\ 0 & - 1 / 2 & 1 / 2\end{matrix} ) ( \begin{matrix}G \\ B \\ R\end{matrix} ) . \qquad ( 3 )$$

An inverse conversion from YCgCo to GBR may be performed using equation (4) according to an embodiment:

$$( \begin{matrix}G \\ B \\ R\end{matrix} ) = ( \begin{matrix}1 & 1 & 0 \\ 1 & - 1 & - 1 \\ 1 & - 1 & 1\end{matrix} ) ( \begin{matrix}Y \\ C g \\ C o\end{matrix} ) . \qquad ( 4 )$$

As shown in equation (3), a forward color space transform matrix that may be used for lossy coding may not be normalized. The magnitude and/or energy of a residue signal in the YCgCo domain may be reduced compared to that of the original residue in the RGB domain. This reduction of a residue signal in the YCgCo domain may compromise the lossy coding performance of YCgCo domain because the YCgCo residual coefficients may be overly quantized by using a same quantization parameter (QP) that may have been used in the RGB domain. In an embodiment, a QP adjustment method may be used where a delta QP may be added to an original QP value when a color space transform may be applied to compensate for the magnitude changes of a YCgCo residual signal. A same delta QP may be applied to both a Y component and Cg and/or Co components. In embodiments implementing equation (3), different rows of a forward transform matrix may not have a same norm. The same QP adjustment may not ensure that both a Y component and Cg and/or Co components have similar amplitude levels as that of a G component and B and/or R components.

In order to ensure that a YCgCo residual signal converted from an RGB residual signal has a similar amplitude as the RGB residual signal, in one embodiment, a pair of scaled forward and inverse transform matrices may be used to convert the residual signal between the RGB domain and the YCgCo domain. More specifically, a forward transform matrix from the RGB domain to the YCgCo domain may be defined by equation (5):

$$( \begin{matrix}Y \\ C g \\ C o\end{matrix} ) = ( ( \begin{matrix}1 / 2 & 1 / 4 & 1 / 4 \\ 1 / 2 & - 1 / 4 & - 1 / 4 \\ 0 & - 1 / 2 & 1 / 2\end{matrix} ) ⊗ ( \begin{matrix}a & a & a \\ a & a & a \\ b & b & b\end{matrix} ) ) ( \begin{matrix}G \\ B \\ R\end{matrix} ) \qquad ( 5 )$$

where ⊗ may indicate an element-wise matrix multiplication of two entries that may be at the same position of two matrices. a, b, and c may be scaling factors to compensate for the norms of different rows in the original forward color space transform matrix, such as that used in equation in (3), which may be derived using equations (6) and (7):

$$\begin{matrix}a = \frac{1}{\sqrt{{( \frac{1}{2} )}^{2} + {( \frac{1}{4} )}^{2} + {( \frac{1}{4} )}^{2}}} & ( 6 ) \\ b = \frac{1}{\sqrt{{( - \frac{1}{2} )}^{2} + {( \frac{1}{2} )}^{2}}} . & ( 7 )\end{matrix}$$

In such an embodiment, an inverse transform from the YCgCo domain to RGB domain may be implemented using equation (8):

$$( \begin{matrix}G \\ B \\ R\end{matrix} ) = ( ( \begin{matrix}1 & 1 & 0 \\ 1 & - 1 & - 1 \\ 1 & - 1 & 1\end{matrix} ) ⊗ ( \begin{matrix}1 / a & 1 / a & 1 / a \\ 1 / a & 1 / a & 1 / a \\ 1 / b & 1 / b & 1 / b\end{matrix} ) ) ( \begin{matrix}Y \\ C g \\ C o\end{matrix} ) . \qquad ( 8 )$$

In equations (5) and (8), the scaling factors may be real numbers that may require float-point multiplication when transforming color space between RGB and YCgCo. To reduce implementation complexity, in an embodiment the multiplications of scaling factors may be approximated by a computationally efficient multiplication with an integer number M followed by an N-bit right shift.

The disclosed color space conversion methods and systems may be enabled and/or disabled at a sequence, picture, or block (e.g., CU, TU) level. For example, in an embodiment, a color space conversion of prediction residue may be enabled and/or disabled adaptively at the coding unit level. An encoder may select an optimal color space between GBR and YCgCo for each CU.

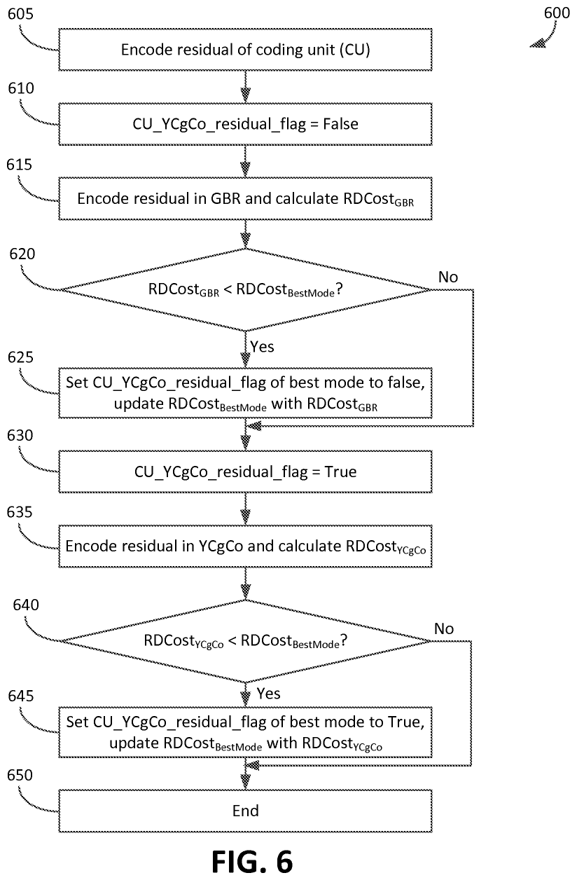

FIG. 6 illustrates exemplary method 600 for an RD optimization process using adaptive residue color conversion at an encoder as described herein. At block 605, a residual of a CU may be encoded using a “best mode” of encoding for that implementation (e.g., intra prediction mode for intra coding, motion vector and reference picture index for inter coding), which may be a preconfigured encoding mode, an encoding mode previously determined to the best available, or another predetermined encoding mode that has been determined to have a lowest or relatively lower RD cost, at least at the point of execution of the functions of block 605. At block 610, a flag, in this example labeled “CU_YCgCo_residual_flag,” but which may be labeled using any term or combination of terms, may be set to “False” (or set to any other indictor indicating false, zero, etc.), indicating that the encoding of the residual of the coding unit is not to be performed using the YCgCo color space. In response to the flag evaluated at block 610 to be false or an equivalent, at block 615, the encoder may perform residual coding in the GBR color space and calculate an RD cost for such encoding (labeled in FIG. 6 as “RDCost_{GBR}”, but here again any label or term may be used to refer to such a cost).

At block 620 a determination may be made as to whether the RD cost for GBR color space encoding is lower than the RD cost for the best mode encoding. If the RD cost for the GBR color space encoding is lower than the RD cost for best mode encoding, at block 625 the CU_YCgCo_residual_flag for the best mode may be set to false or its equivalent (or may be left set to false or its equivalent) and the RD cost for the best mode may be set to the RD cost for residual coding in the GBR color space. Method 600 may progress to block 630 where the CU_YCgCo_residual_flag may be set to true or an equivalent indicator.

If, at block 620, the RD cost for the GBR color space is determined to be higher than or equal to the RD cost for the best mode encoding, the RD cost for the best mode encoding may be left at the value to which it was set before evaluation of block 620 and block 625 may be bypassed. Method 600 may progress to block 630 where the CU_YCgCo_residual_flag may be set to true or an equivalent indicator. The setting of the CU_YCgCo_residual_flag to true (or an equivalent indicator) at block 630 may facilitate the encoding of the residual of the coding unit using the YCgCo color space and therefore the evaluation of the RD cost of encoding using the YCgCo color space compared to the RD cost of the best mode encoding as described below.

At block 635, the residual of the coding unit may be encoded using the YCgCo color space and the RD cost of such an encoding may be determined (such a cost is labeled in FIG. 6 as “RDCosty_{CgCo}”, but here again any label or term may be used to refer to such a cost).

At block 640 a determination may be made as to whether the RD cost for YCgCo color space encoding is lower than the RD cost for the best mode encoding. If the RD cost for the YCgCo color space encoding is lower than the RD cost for best mode encoding, at block 645 the CU_YCgCo_residual_flag for the best mode may be set to true or its equivalent (or may be left set to true or its equivalent) and the RD cost for the best mode may be set to the RD cost for residual coding in the YCgCo color space. Method 600 may terminate at block 650.

If, at block 640, the RD cost for the YCgCo color space is determined to be higher than the RD cost for the best mode encoding, the RD cost for the best mode encoding may be left at the value to which it was set before evaluation of block 640 and block 645 may be bypassed. Method 600 may terminate at block 650.

As one skilled in the art will appreciate, the disclosed embodiments, including method 600 and any subset thereof, may allow the comparison of GBR and YCgCo color space encoding and their respective RD costs, which may allow the selection of the color space encoding having the lower RD cost.

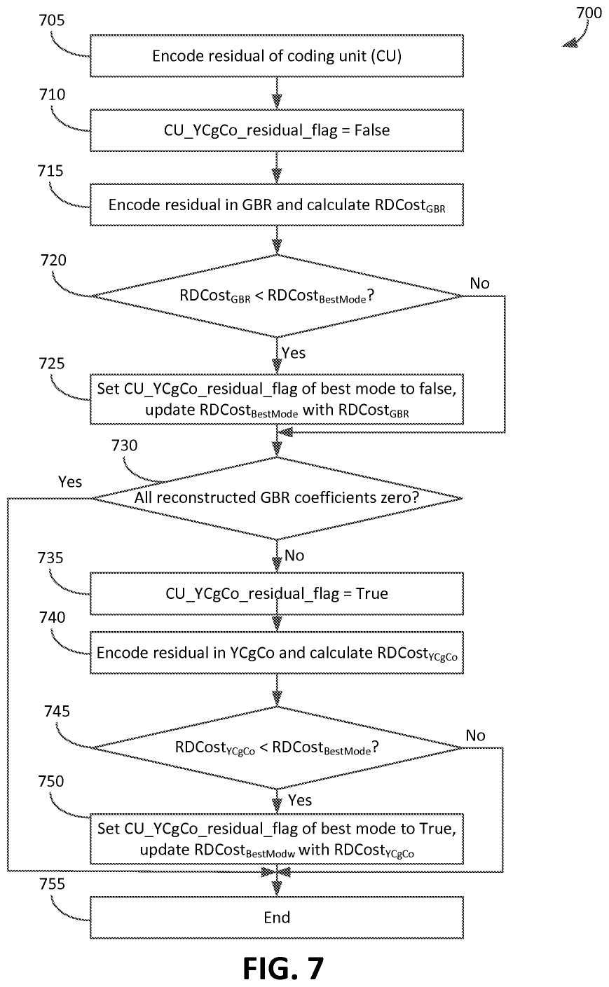

FIG. 7 illustrates another exemplary method 700 for an RD optimization process using adaptive residue color conversion at an encoder as described herein. In an embodiment, an encoder may attempt to use YCgCo color space for residual coding when at least one of the reconstructed GBR residuals in the current coding unit is not zero. If all of the reconstructed residuals are zero, it may indicate that the prediction in GBR color space may be sufficient and a conversion to YCgCo color space may not further improve the efficiency of residue coding. In such an embodiment, the number of examined cases may be reduced for RD optimization and the encoding process may be performed more efficiently. Such an embodiment may be implemented in systems using large quantization parameters, such as large quantization step sizes.

At block 705, a residual of a CU may be encoded using a “best mode” of encoding for that implementation (e.g., intra prediction mode for intra coding, motion vector and reference picture index for inter coding), which may be a preconfigured encoding mode, an encoding mode previously determined to the best available, or another predetermined encoding mode that has been determined to have a lowest or relatively lower RD cost, at least at the point of execution of the functions of block 705. At block 710, a flag, in this example labeled “CU_YCgCo_residual_flag,” may be set to “False” (or set to any other indictor indicating false, zero, etc.), indicating that the encoding of the residual of the coding unit is not to be performed using the YCgCo color space. Note that, here again, such a flag may be labeled using any term or combination of terms. In response to the flag evaluated at block 610 to be false or an equivalent, at block 715, the encoder may perform residual coding in the GBR color space and calculate an RD cost for such encoding (labeled in FIG. 7 as “RDCost_{GBR}”, but, here again, any label or term may be used to refer to such a cost).

At block 720 a determination may be made as to whether the RD cost for GBR color space encoding is lower than the RD cost for the best mode encoding. If the RD cost for the GBR color space encoding is lower than the RD cost for best mode encoding, at block 725 the CU_YCgCo_residual_flag for the best mode may be set to false or its equivalent (or may be left set to false or its equivalent) and the RD cost for the best mode may be set to the RD cost for residual coding in the GBR color space.

If, at block 720, the RD cost for the GBR color space is determined to be higher than or equal to the RD cost for the best mode encoding, the RD cost for the best mode encoding may be left at the value to which it was set before evaluation of block 720 and block 725 may be bypassed.

At block 730, a determination may be made as to whether at least one of the reconstructed GBR coefficients is not zero (i.e., whether all reconstructed GBR coefficients are equal to zero). If there is at least one reconstructed GBR coefficient that is not zero, at block 735 the CU_YCgCo_residual_flag may be set to true or an equivalent indicator. The setting of the CU_YCgCo_residual_flag to true (or an equivalent indicator) at block 735 may facilitate the encoding of the residual of the coding unit using the YCgCo color space and therefore the evaluation of the RD cost of encoding using the YCgCo color space compared to the RD cost of the best mode encoding as described below.

Where at least one reconstructed GBR coefficient is not zero, at block 740 the residual of the coding unit may be encoded using the YCgCo color space and the RD cost of such an encoding may be determined (such a cost is labeled in FIG. 7 as “RDCosty_{CgCo}”, but, here again, any label or term may be used to refer to such a cost).

At block 745 a determination may be made as to whether the RD cost for YCgCo color space encoding is lower than the value of the RD cost for the best mode encoding. If the RD cost for YCgCo color space encoding is lower than the RD cost for best mode encoding, at block 750 the CU_YCgCo_residual_flag for the best mode may be set to true or its equivalent (or may be left set to true or its equivalent) and the RD cost for the best mode may be set to the RD cost for residual coding in the YCgCo color space. Method 700 may terminate at block 755.

If, at block 745, the RD cost for the YCgCo color space is determined to be higher than or equal to the RD cost for the best mode encoding, the RD cost for the best mode encoding may be left at the value to which it was set before evaluation of block 745 and block 750 may be bypassed. Method 700 may terminate at block 755.

As one skilled in the art will appreciate, the disclosed embodiments, including method 700 and any subset thereof, may allow the comparison of GBR and YCgCo color space encoding and their respective RD costs, which may allow the selection of the color space encoding having the lower RD cost. Method 700 of FIG. 7 may provide a more efficient means of determining an appropriate setting for a flag such as the exemplary CU_YCgCo_residual_coding_flag described herein, while method 600 of FIG. 6 may provide a more thorough means of determining an appropriate setting for a flag such as the exemplary CU_YCgCo_residual_coding_flag described herein. In either embodiment, or any variation, subset, or implementation using any one or more aspects thereof, all of which are contemplated as within the scope of the instant disclosure, the value of such a flag may be transmitted in an encoded bitstream, such as those described in regard to FIG. 2 and any other encoder described herein.

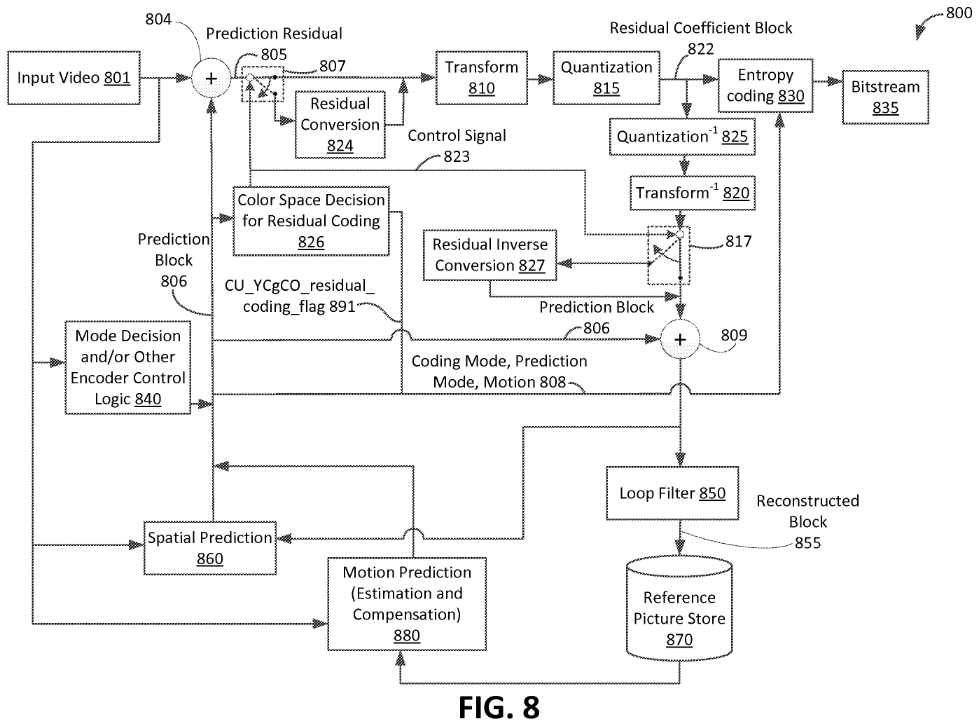

FIG. 8 illustrates a block diagram of block-based single layer video encoder 800 that may, for example, be implemented according to an embodiment to provide a bitstream to receiver 192 of system 191 of FIG. 1. As shown in FIG. 8, an encoder such as encoder 800 may use techniques such as spatial prediction (that may also be referred to as “intra-prediction”) and temporal prediction (that may also be referred to as “inter-prediction” or “motion-compensated-prediction”) to predict input video signal 801 in an effort to increase compression efficiency. Encoder 800 may include mode decision and/or other encoder control logic 840 that may determine a form of prediction. Such a determination may be based, at least in part, on criteria such as rate-based criteria, distortion-based criteria, and/or a combination thereof. Encoder 800 may provide one or more prediction blocks 806 to adder element 804, which may generate and provide prediction residual 805 (that may be a difference signal between an input signal and a prediction signal) to transform element 810. Encoder 800 may transform prediction residual 805 at transform element 810 and quantize prediction residual 805 at quantization element 815. The quantized residual, together with the mode information (e.g., intra- or inter-prediction) and prediction information (motion vectors, reference picture indexes, intra prediction modes, etc.) may be provided to entropy coding element 830 as residual coefficient block 822. Entropy coding element 830 may compress the quantized residual and provide it with output video bitstream 835. Entropy coding element 830 may also, or instead, use coding mode, prediction mode, and/or motion information 808 in generating output video bitstream 835.

In an embodiment, encoder 800 may also, or instead, generate a reconstructed video signal by applying inverse quantization to residual coefficient block 822 at inverse quantization element 825 and inverse transform at inverse transform element 820 to generate a reconstructed residual that may be added back to prediction signal 806 at adder element 809. In an embodiment, a residual inverse conversion of such a reconstructed residual may be generated by residual inverse conversion element 827 and provided to adder element 809. In such an embodiment, residual coding element 826 may provide an indication of a value of CU_YCgCo_residual_coding_flag 891 (or a CU_YCgCo_residual_flag or any other one or more flags or indicators performing the functions or providing the indications described herein in regard to the described CU_YCgCo_residual_coding_flag and/or the described CU_YCgCo_residual_flag) to control switch 817 via control signal 823. Control switch 817 may, responsive to receiving control signal 823 indicating the receipt of such a flag, direct the reconstructed residual to residual inverse conversion element 827 for generation of the residual inverse conversion of the reconstructed residual. The value of flag 891 and/or control signal 823 may indicate a decision by the encoder of whether or not to apply a residual conversion process that may include both forward residual conversion 824 and reverse residual conversion 827. In some embodiments, control signal 823 may take on different values as the encoder evaluates the costs and benefits of applying or not applying a residual conversion process. For example, the encoder may evaluate rate distortion costs of applying a residual conversion process to portions of a video signal.

The resulting reconstructed video signal generated by adder 809 may, in some embodiments, be processed using a loop filter process implemented at loop filter element 850 (e.g., by using one or more of a deblocking filter, sample adaptive offsets, and/or adaptive loop filters). The resulting reconstructed video signal, in some embodiments in the form of reconstructed block 855, may be stored at reference picture store 870, where it may be used to predict future video signals, for example by motion prediction (estimation and compensation) element 880 and/or spatial prediction element 860. Note that in some embodiments, a resulting reconstructed video signal generated by adder element 809 may be provided to spatial prediction element 860 without processing by an element such as loop filter element 850.

As shown in FIG. 8, in an embodiment, an encoder such as encoder 800 may determine a value of CU_YCgCo_residual_coding_flag 891 (or a CU_YCgCo_residual_flag or any other one or more flags or indicators performing the functions or providing the indications described herein in regard to the described CU_YCgCo_residual_coding_flag and/or the described CU_YCgCo_residual_flag) at color space decision for residual coding element 826. Color space decision for residual coding element 826 may provide an indication of such a flag to control switch 807 via control signal 823. Control switch 807 may responsively direct prediction residual 805 to residual conversion element 824 upon receiving control signal 823 indicating receipt of such a flag so that an RGB to YCgCo conversion process may be adaptively applied to prediction residual 805 at residual conversion element 824. In some embodiments, this conversion process may be performed before transform and quantization are performed on the coding unit being processed by transform element 810 and quantization element 815. In some embodiments, this conversion process may also, or instead, be performed before inverse transform and inverse quantization are performed on the coding unit being processed by inverse transform element 820 and inverse quantization element 825. In some embodiments, CU_YCgCo_residual_coding_flag 891 may also, or instead, be provided to entropy coding element 830 for inclusion in bitstream 835.

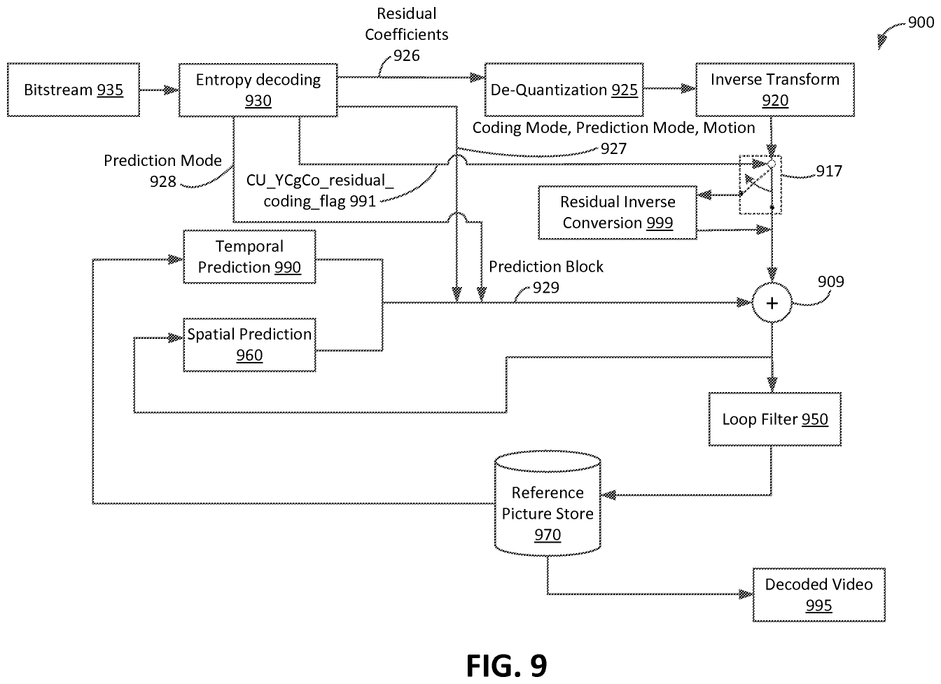

FIG. 9 illustrates a block diagram of block-based single layer decoder 900 that may receive video bitstream 935, which may be a bitstream such as bitstream 835 that may be generated by encoder 800 of FIG. 8. Decoder 900 may reconstruct bitstream 935 for display on a device. Decoder 900 may parse bitstream 935 at entropy decoder element 930 to generate residual coefficients 926. Residual coefficients 926 may be inverse quantized at de-quantization element 925 and/or may be inverse transformed at inverse transform element 920 to obtain a reconstructed residual that may be provided to adder element 909. Coding mode, prediction mode, and/or motion information 927 may be used to obtain a prediction signal, in some embodiments using one or both of spatial prediction information provided by spatial prediction element 960 and/or temporal prediction information provided by temporal prediction element 990. Such a prediction signal may be provided as prediction block 929. The prediction signal and the reconstructed residual may be added at adder element 909 to generate a reconstructed video signal that may be provided to loop filter element 950 for loop filtering and that may be stored in reference picture store 970 for use in displaying pictures and/or decoding video signals. Note that prediction mode 928 may be provided by entropy decoding element 930 to adder element 909 for use in generating a reconstructed video signal that may be provided to loop filter element 350 for loop filtering.

In an embodiment, decoder 900 may decode bitstream 935 at entropy decoding element 930 to determine CU_YCgCo_residual_coding_flag 991 (or a CU_YCgCo_residual_flag or any other one or more flags or indicators performing the functions or providing the indications described herein in regard to the described CU_YCgCo_residual_coding_flag and/or the described CU_YCgCo_residual_flag), which may have been encoded into bitstream 935 by an encoder such as encoder 800 of FIG. 8. The value of CU_YCgCo_residual_coding_flag 991 may be used to determine whether a YCgCo to RGB inverse conversion process may be performed at residual inverse conversion element 999 on the reconstructed residual generated by inverse transform element 920 and provided to adder element 909. In an embodiment, flag 991, or a control signal indicating the receipt thereof, may be provided to control switch 917 that may responsively direct the reconstructed residual to residual inverse conversion element 999 to generate the residual inverse conversion of the reconstructed residual.

By performing an adaptive color space conversion to a prediction residual, but not as part of motion compensation prediction or intra-prediction, in an embodiment, a video coding system's complexity may be reduced because such embodiments may not require an encoder and/or a decoder to store a prediction signal in two different color spaces.

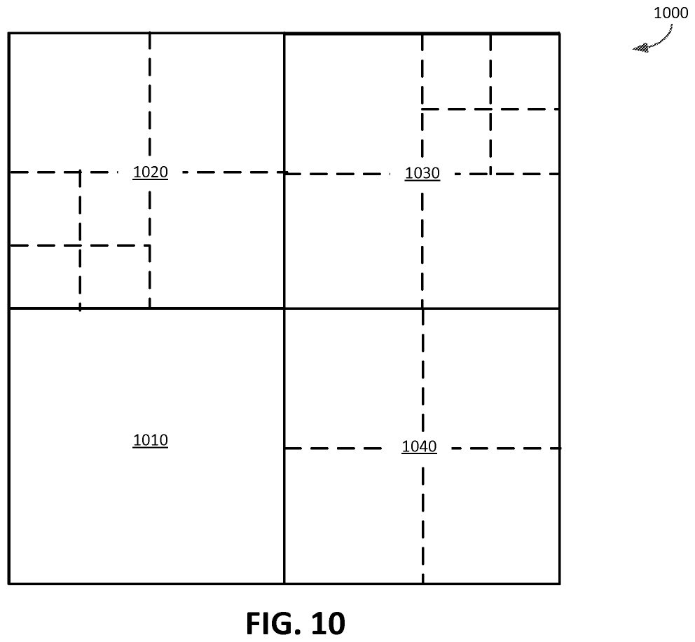

To improve the residual coding efficiency, transform coding of a prediction residue may be performed by partitioning a residue block into multiple square transform units, where the possible TU sizes may be 4×4, 8×8, 16×16 and/or 32×32. FIG. 10 illustrates exemplary partitioning 1000 of PUs into TUs, where left-bottom PU 1010 may represent an embodiment where a TU size may be equal to a PU size, and PUs 1020, 1030, and 1040 may represent an embodiment where each respective exemplary PU may be divided into multiple TUs.

In an embodiment, color space conversion of a prediction residual may be adaptively enabled and/or disabled at a TU level. Such an embodiment may provide finer granularity of switching between different color spaces compared to enabling and/or disabling an adaptive color transform at a CU level. Such an embodiment may improve the coding gain that an adaptive color space conversion may achieve.

Referring again to exemplary encoder 800 of FIG. 8, in order to select a color space for the residual coding of a CU, an encoder such as exemplary encoder 800 may test each coding mode (e.g., intra-coding mode, inter-coding mode, intra-block copy mode) twice, once with a color space conversion and once without a color space conversion. In some embodiments, in order improve the efficiency of such encoding complexity, various “fast”, or more efficient, encoding logics may be used as described herein.

In an embodiment, because YCgCo may provide a more compact representation of an original color signal than RGB, an RD cost of enabling a color space transform may be determined and compared to an RD cost of disabling a color space transform. In some such embodiments, a calculation of an RD cost of disabling a color space transform may be conducted if there is at least one non-zero coefficient when a color space transform is enabled.

In order to reduce a number of tested coding modes, the same coding modes may be used for both RGB and YCgCo color spaces in some embodiments. For intra-mode, selected luma and chroma intra predictions may be shared between the RGB and the YCgCo spaces. For inter-mode, a selected motion vector, reference picture, and motion vector predictor may be shared between the RGB and YCgCo color spaces. For intra-block copy mode, a selected block vector and block vector predictor may be shared between the RGB and YCgCo color spaces. To further reduce encoding complexity, in some embodiments TU partitions may be shared between the RGB and YCgCo color spaces.

Because there may be correlations between the three color components (Y, Cg, and Co in YCgCo domain, and G, B, and R in RGB domain), the same intra prediction direction may be selected for the three color components some embodiments. A same intra prediction mode may be used for all three color components in each of the two color spaces.

Because there may be correlations between CUs in a same region, one CU may select a same color space (e.g., either RGB or YCgCo) as its parent CU for encoding its residual signal. Alternatively, a child CU may derive a color space from information associated with its parent, such as a selected color space and/or an RD cost of each color space. In an embodiment, encoding complexity may be reduced by not checking an RD cost of a residual coding in the RGB domain for one CU if a residual of its parent CU is encoded in YCgCo domain. Checking an RD cost of a residual coding in the YCgCo domain may also, or instead, be skipped if a residual of a child CU's parent CU is encoded in the RGB domain. In some embodiments, an RD cost of a child CU's parent CU in two color spaces may be used for the child CU if the two color spaces are tested in the parent CU's encoding. The RGB color space may be skipped for a child CU if the child CU's parent CU selects the YCgCo color space and the RD cost of YCgCo is less than that of RGB, and vice-versa.

Many prediction modes may be supported by some embodiments, including many intra prediction modes that may include many intra angular prediction modes, one or more DC modes, and/or one or more planar prediction modes. Testing a residual coding with a color space transform for all such intra prediction modes may increase the complexity of an encoder. In an embodiment, instead of calculating a full RD cost for all supported intra prediction modes, a subset of N intra prediction candidates may be selected from the supported modes without considering the bits of residual coding. The N selected intra prediction candidates may be tested in a converted color space by calculating an RD cost after applying residual coding. A best mode that has the lowest RD cost among the supported modes may be selected as the intra prediction mode in the converted color space.

As noted herein, the disclosed color space conversion systems and methods may be enabled and/or disabled at a sequence level and/or at a picture and/or slice level. In an exemplary embodiment illustrated in Table 3 below, a syntax element (an example of which is highlighted in bold in Table 3, but which may take any form, label, terminology, or combination thereof, all of which are contemplated as within the scope of the instant disclosure) may be used in a sequence parameter set (SPS) to indicate if the residual color space conversion coding tool is enabled. In some such embodiments, as color space conversion is applied to video content that has the same resolutions of a luma component and chroma components, the disclosed adaptive color space conversion systems and methods may be enabled for the “444” chroma format. In such embodiments, color space conversion to 444 chroma format may be constrained at a relatively high level. In such an embodiment, a bitstream conformance constraint may be applied to enforce the disabling of color space conversion when a non-444 color format may be used.

TABLE 3
Exemplary sequence parameter set syntax

Descriptor

seq_parameter_set_rbsp( ) {

| | |
|---|---|
| ... | |
| sps_{—}residual_{—}csc_{—}flag | u(1) |
| ... | |

}

In an embodiment, the exemplary syntax element “sps_residual_csc_flag” being equal to 1 may indicate that a residual color space conversion coding tool may be enabled. The exemplary syntax element sps_residual_csc_flag being equal to 0 may indicate that a residual color space conversion may disabled and that the flag CU_YCgCo_residual_flag at a CU level is inferred to be 0. In such an embodiment, when a ChromaArrayType syntax element is not equal to 3, the value of the exemplary sps_residual_csc_flag syntax element (or its equivalent) may be equal to 0 to maintain bitstream conformance.

In another embodiment, as illustrated in Table 4 below, an sps_residual_csc_flag exemplary syntax element (an example of which is highlighted in bold in Table 4, but which may take any form, label, terminology, or combination thereof, all of which are contemplated as within the scope of the instant disclosure) may be signaled depending on a value of a ChromaArraryType syntax element. In such an embodiment, if an input video is in 444 color format (i.e., ChromaArrayType is equal to 3, for example, “ChromaArrayType==3” in Table 4), the sps_residual_csc_flag exemplary syntax element may be signaled to indicate whether the color space conversion is enabled. If such an input video is not in 444 color format (i.e., ChromaArrayType is not equal to 3), the sps_residual_csc_flag exemplary syntax element may not be signaled and may be set to be equal to 0.

TABLE 4
Exemplary sequence parameter set syntax

Descriptor

seq_parameter_set_rbsp( ) {

...

if( ChromaArrayType == 3 )

| | |
|---|---|
| sps_{—}residual_{—}csc_{—}flag | u(1) |
| ... | |

}

If a residual color space conversion coding tool is enabled, in an embodiment, another flag may be added at the CU level and/or TU level as described herein to enable the color space conversion between GBR and YCgCo color spaces.

In an embodiment, an example of which is illustrated below in Table 5, an exemplary coding unit syntax element “cu_ycgco_residue_flag” (an example of which is highlighted in bold in Table 5, but which may take any form, label, terminology, or combination thereof, all of which are contemplated as within the scope of the instant disclosure) being equal to 1 may indicate that a residual of the coding unit may be encoded and/or decoded in the YCgCo color space. In such an embodiment, the cu_ycgco_residue_flag syntax element or its equivalent being equal to 0 may indicate that a residual of the coding unit may be encoded in the GBR color space.

TABLE 5
Exemplary coding unit syntax

Descriptor

coding_unit( x0, y0, log2CbSize ) {
if( transquant_bypass_enabled_flag )

| | |
|---|---|
| cu_transquant_bypass_flag | ae(v) |

if( slice_type != I )

| | |
|---|---|
| cu_skip_flag[ x0 ][ y0 ] | ae(v) |

```
  nCbS = ( 1 << log2CbSize )
  ...
```

if( !pcm_flag[ x0 ][ y0 ] ) {
if( CuPredMode[ x0 ][ y0 ] != MODE_INTRA &&

| | |
|---|---|
| !( PartMode = = PART_2Nx2N && merge_flag[ x0 ][ y0 ] ) \| \| | |
| CuPredMode[ x0 ][ y0 ] = = MODE_INTRA && | |
| intra_bc_flag[ x0 ][ y0 ] ) | |
| rqt_root_cbf | ae(v) |

if( rqt_root_cbf ) {

| | |
|---|---|
| if( sps_residual_csc_flag ) | |
| cu_{—}ycgco_{—}residual_{—}flag | ae(v) |

MaxTrafoDepth = ( CuPredMode[ x0 ][ y0 ] = = MODE_INTRA ?

```
  ( max_transform_hierarchy_depth_intra +
  IntraSplitFlag ) :
max_transform_hierarchy_depth_inter )
```

transform_tree( x0, y0, x0, y0, log2CbSize, 0, 0 )

}
}

}
}

In another embodiment, an example of which is illustrated below in Table 6, an exemplary transform unit syntax element “tu_ycgco_residue_flag” (an example of which is highlighted in bold in Table 6, but which may take any form, label, terminology, or combination thereof, all of which are contemplated as within the scope of the instant disclosure) being equal to 1 may indicate that a residual of a transform unit may be encoded and/or decoded in YCgCo color space. In such an embodiment, the tu_ycgco_residue_flag syntax element or its equivalent being equal to 0 may indicates that a residual of a transform unit may be encoded in GBR color space.

TABLE 6
Exemplary transform unit syntax

Descriptor

```
transform_unit( x0, y0, xBase, yBase, log2TrafoSize, trafoDepth, blkIdx ) {
  log2TrafoSizeC = log2TrafoSize − ( ChromaArrayType = = 3 ? 0 : 1 )
  cbfLuma = cbf_luma[ x0 ][ y0 ][ trafoDepth ]
  cbfChroma = cbf_cb[ x0 ][ y0 ][ trafoDepth ] | |
```

cbf_cr[ x0 ][ y0 ][ trafoDepth ]

```
( ChromaArrayType = = 2 &&
  ( cbf_cb[ x0 ][ y0 + ( 1 << log2TrafoSizeC ) ][ trafoDepth ] | |
  cbf_cr[ x0 ][ y0 + ( 1 << log2TrafoSizeC ) ][ trafoDepth ] ) )
```

...

if( sps_residual_csc_flag && (cbfLuma || cbfChroma) )

| | |
|---|---|
| tu_{—}ycgco_{—}residual_{—}flag | ae(v) |

```
  residual_coding( x0, y0, log2TrafoSize, 0 )
if( log2TrafoSize > 2 | | ChromaArrayType = = 3 ) {
  if( cross_component_prediction_enabled_flag && cbfLuma &&
```

```
( CuPredMode[ x0 ][ y0 ] = = MODE_INTER | |
  intra_bc_flag[ x0 ][ y0 ] | |
  intra_chroma_pred_mode[ x0 ][ y0 ] = = 4) )
cross_comp_pred( x0, y0, 0 )
```

for( tIdx = 0; tIdx < ( ChromaArrayType = = 2 ? 2 : 1 ); tIdx++ )

if( cbf_cb[ x0 ][ y0 + ( tIdx << log2TrafoSizeC ) ][ trafoDepth ] )
residual_coding( x0, y0 + ( tIdx <<

log2TrafoSizeC ), log2TrafoSizeC, 1 )

if( cross_component_prediction_enabled_flag && cbfLuma &&

```
( CuPredMode[ x0 ][ y0 ] = = MODE_INTER | |
  intra_bc_flag[ x0 ][ y0 ] | |
  intra_chroma_pred_mode[ x0 ][ y0 ] = = 4) )
cross_comp_pred( x0, y0, 1 )
```

for( tIdx = 0; tIdx < ( ChromaArrayType = = 2 ? 2 : 1 ); tIdx++ )

if( cbf_cr[ x0 ][ y0 + ( tIdx << log2TrafoSizeC ) ][ trafoDepth ] )
residual_coding( x0, y0 + ( tIdx <<

log2TrafoSizeC ), log2TrafoSizeC, 2 )

} else if( blkIdx = = 3 ) {
for( tIdx = 0; tIdx < ( ChromaArrayType = = 2 ? 2 : 1 ); tIdx++ )

```
if( cbf_cb[ xBase ][ yBase + ( tIdx <<
  log2TrafoSizeC ) ][ trafoDepth ] )
  residual_coding( xBase, yBase + ( tIdx <<
```

log2TrafoSize ), log2TrafoSize, 1 )

for( tIdx = 0; tIdx < ( ChromaArrayType = = 2 ? 2 : 1 ); tIdx++ )

```
if( cbf_cr[ xBase ][ yBase + ( tIdx <<
  log2TrafoSizeC ) ][ trafoDepth ] )
  residual_coding( xBase, yBase + ( tIdx <<
```

log2TrafoSize ), log2TrafoSize, 2 )

}

}
}

Some interpolation filters may be less efficient at interpolating fractional pixels for motion-compensated prediction that may be used in screen content coding in some embodiments. For example, 4-tap filters may not be as accurate at interpolating B and R components at fractional positions when coding RGB videos. In lossless coding embodiments, 8-tap luma filters may not be the most efficient means of preserving useful high-frequency texture information contained in an original luma component. In an embodiment, separate indications of interpolation filters may be used for different color components.

In one such embodiment, one or more default interpolation filters (e.g., a set of 8-tap filters, a set of 4-tap filters) may be used as candidate filters for a fractional-pixel interpolation process. In another embodiment, sets of interpolation filters that differ from default interpolation filters may be explicitly signaled in a bit-stream. To enable adaptive filter selection for different color components, signaling syntax elements may be used that specify the interpolation filters that are selected for each color component. The disclosed filter selection systems and methods may be used at various coding levels, such as sequence-level, picture and/or slice-level, and CU level. The selection of an operational coding level may be made based on the coding efficiency and/or the computational and/or operational complexity of the available implementations.

In embodiments where default interpolation filters are used, flags may be used to indicate that a set of 8-tap filters or a set of 4-tap filters may be used for fractional-pixel interpolation of a color component. One such flag may indicate a filter selection for a Y component (or a G component in RGB color space embodiments) and another such flag may be used for Cb and Cr components (or B and R components in RGB color space embodiments). The tables below provide examples of such flags that may be signaled at a sequence level, a picture and/or slice-level, and a CU level.

Table 7 below illustrates an embodiment where such flags are signaled to allow the selection of default interpolation filters at a sequence level. The disclosed syntax may be applied to any parameter set, including a video parameter set (VPS), a sequence parameter set (SPS), and a picture parameter set (PPS). Table 7 illustrates an embodiment where exemplary syntax elements may be signaled at a SPS.

TABLE 7
Exemplary signaling of a selection of interpolation
filters at a sequence level

Descriptor

seq_parameter_set_rbsp( ) {

| | |
|---|---|
| ... | |
| sps_{—}luma_{—}use_{—}default_{—}filter_{—}flag | u(1) |
| sps_{—}chroma_{—}use_{—}default_{—}filter_{—}flag | u(1) |
| ... | |

}

In such an embodiment, an exemplary syntax element “sps_luma_use_default_filter_flag” (an example of which is highlighted in bold in Table 7, but which may take any form, label, terminology, or combination thereof, all of which are contemplated as within the scope of the instant disclosure) being equal to 1 may indicate that a luma component of all pictures associated with a current sequence parameter set may use a same set of luma interpolation filters (e.g., a set of default luma filters) for interpolation of fractional pixels. In such an embodiment, the exemplary syntax element sps_luma_use_default_filter_flag being equal to 0 may indicate that a luma component of all pictures associated with a current sequence parameter set may use a same set of chroma interpolation filters (e.g., a set of default chroma filters) for interpolation of fractional pixels.

In such an embodiment, an exemplary syntax element “sps_chroma_use_default_filter_flag” (an example of which is highlighted in bold in Table 7, but which may take any form, label, terminology, or combination thereof, all of which are contemplated as within the scope of the instant disclosure) being equal to 1 may indicate that a chroma component of all pictures associated with a current sequence parameter set may use a same set of chroma interpolation filters (e.g., a set of default chroma filters) for interpolation of fractional pixels. In such an embodiment, the exemplary syntax element sps_chroma_use_default_filter_flag being equal to 0 may indicate that a chroma component of all pictures associated with a current sequence parameter set may use a same set of luma interpolation filters (e.g., a set of default luma filters) for interpolation of fractional pixels.

In an embodiment where flags may be signaled at a picture and/or slice level to facilitate the selection of fractional interpolation filters at the picture and/or slice level (i.e., for a given color component, all CUs in a picture and/or slice may use the same interpolation filters). Table 8 below illustrates an example of signaling using syntax elements in a slice segment header according to an embodiment.

TABLE 8
Exemplary signaling of a selection of interpolation
filters at a picture and/or slice level

Descriptor

slice_segment_header( ) {
...

if( tiles_enabled_flag | |
entropy_coding_sync_enabled_flag ) {

| | |
|---|---|
| num_entry_point_offsets | ue(v) |
| if( num_entry_point_offsets > 0 ) { | |

| | |
|---|---|
| offset_len_minus1 | ue(v) |
| for( i = 0; i < num_entry_point_offsets; i++ ) | |

| | |
|---|---|
| entry_point_offset[ i ] | u(v) |

}

}
if( slice_type == P || slice_type == B ) {

| | |
|---|---|
| slice_{—}luma_{—}use_{—}default_{—}filter_{—}flag | u(1) |
| slice_{—}chroma_{—}use_{—}default_{—}filter_{—}flag | u(1) |

}
if( slice_header_extension_present_flag ) {

| | |
|---|---|
| slice_header_extension_length | ue(v) |
| for( i = 0; i < slice_header_extension_length; i++) | |

| | |
|---|---|
| slice_header_extension_data_byte[ i ] | u(8) |

}
byte_alignment( )

}

In such an embodiment, an exemplary syntax element “slice_luma_use_default_filter_flag” (an example of which is highlighted in bold in Table 8, but which may take any form, label, terminology, or combination thereof, all of which are contemplated as within the scope of the instant disclosure) being equal to 1 may indicate that a luma component of a current slice may use a same set of luma interpolation filters (e.g., a set of default luma filters) for interpolation of fractional pixels. In such an embodiment, the slice_luma_use_default_filter_flag exemplary syntax element being equal to 0 may indicate that a luma component of a current slice may use a same set of chroma interpolation filters (e.g., a set of default chroma filters) for interpolation of fractional pixels.

In such an embodiment, an exemplary syntax element “slice_chroma_use_default_filter_flag” (an example of which is highlighted in bold in Table 8, but which may take any form, label, terminology, or combination thereof, all of which are contemplated as within the scope of the instant disclosure) being equal to 1 may indicate that a chroma component of a current slice may use a same set of chroma interpolation filters (e.g., a set of default chroma filters) for interpolation of fractional pixels. In such an embodiment, the exemplary syntax element slice_chroma_use_default_filter_flag being equal to 0 may indicate that a chroma component of a current slice may use a same set of luma interpolation filter (e.g., a set of default luma filters) for interpolation of fractional pixels.

In an embodiment where flags may be signaled at a CU level to facilitate the selection of interpolation filters at the CU level, in an embodiment, such flags may be signaled using coding unit syntax as shown in Table 9. In such an embodiment, color components of a CU may adaptively select one or more interpolation filters that may provide a prediction signal for that CU. Such selections may represents coding improvements that may be achieved by adaptive interpolation filter selection.

TABLE 9
Exemplary signaling of a selection of
interpolation filters at a CU level

Descriptor

coding_unit( x0, y0, log2CbSize ) {

if( transquant_bypass_enabled_flag )

| | |
|---|---|
| cu_transquant_bypass_flag | ae(v) |

if( slice_type != I ) {

| | |
|---|---|
| cu_skip_flag[ x0 ][ y0 ] | ae(v) |
| cu_{—}use_{—}default_{—}filter_{—}flag | ae(v) |
| if(!cu_use_default_filter_flag) { | |

| | |
|---|---|
| cu_luma_use_default_filter_flag | ae(v) |
| if(!cu_luma_use_default_filter_flag ) | |

| | |
|---|---|
| cu_chroma_use_default_filter_flag | ae(v) |

}

}
nCbS = ( 1 << log2CbSize )
if( cu_skip_flag[ x0 ][ y0 ] )

prediction_unit( x0, y0, nCbS, nCbS )

else {
......
}

}

In such an embodiment, an exemplary syntax element “cu_use_default_filter_flag” (an example of which is highlighted in bold in Table 9, but which may take any form, label, terminology, or combination thereof, all of which are contemplated as within the scope of the instant disclosure) being equal to 1 indicates that both luma and chroma may use a default interpolation filter for interpolation of fractional pixels. In such an embodiment, the cu_use_default_filter_flag exemplary syntax element or its equivalent being equal to 0 may indicate that either a luma component or a chroma component of the current CU may use a different set of interpolation filters for interpolation of fractional pixels.

In such an embodiment, an exemplary syntax element “cu_luma_use_default_filter_flag” (an example of which is highlighted in bold in Table 9, but which may take any form, label, terminology, or combination thereof, all of which are contemplated as within the scope of the instant disclosure) being equal to 1 may indicate that a luma component of a current CU uses a same set of luma interpolation filters (e.g., a set of default luma filters) for interpolation of fractional pixels. In such an embodiment, the exemplary syntax element cu_luma_use_default_filter_flag being equal to 0 may indicate that a luma component of a current CU may use a same set of chroma interpolation filters (e.g., a set of default chroma filters) for interpolation of fractional pixels.

In such an embodiment, an exemplary syntax element “cu_chroma_use_default_filter_flag” (an example of which is highlighted in bold in Table 9, but which may take any form, label, terminology, or combination thereof, all of which are contemplated as within the scope of the instant disclosure) being equal to 1 may indicate that a chroma component of a current CU may uses a same set of chroma interpolation filters (e.g., a set of default chroma filters) for interpolation of fractional pixels. In such an embodiment, the exemplary syntax element cu_chroma_use_default_filter_flag being equal to 0 may indicate that a chroma component of a current CU may uses a same set of luma interpolation filters (e.g., a set of default luma filters) for interpolation of fractional pixels.

In an embodiment, coefficients of interpolation filter candidates may be explicitly signaled in a bitstream. Arbitrary interpolation filters that may differ from default interpolation filters may be used for the fractional-pixel interpolation processing of a video sequence. In such an embodiment, to facilitate delivery of filter coefficients from an encoder to a decoder, an exemplary syntax element “interp_filter_coef_set( )” (an example of which is highlighted in bold in Table 10, but which may take any form, label, terminology, or combination thereof, all of which are contemplated as within the scope of the instant disclosure) may be used to carry the filter coefficients in the bitstream. Table 10 illustrates a syntax structure for signaling such coefficients of interpolation filter candidates.

TABLE 10
Exemplary signaling of an interpolation filter

Descriptor

interp_filter_coef_set ( ) {

| | |
|---|---|
| arbitrary_{—}interp_{—}filter_{—}used_{—}flag | u(1) |
| if (arbitrary_luma_filter_used_flag) { | |

| | |
|---|---|
| num_{—}interp_{—}filter_{—}set | u(5) |
| interp_{—}filter_{—}coeff_{—}shifting | u(5) |
| for(i = 0; i < number_of_interp_filter_set; | |
| i++) { | |

```
  num_{—}interp_{—}filter[i]
  num_{—}interp_{—}filter_{—}coeff[i]
  for (j = 0; j <
  number_of_interp_filter[i]; j++) {
```

for (1 = 0; 1 <
number_of_filter_coeff[i] ; 1++) {

| | |
|---|---|
| interp_{—}filter_{—}coeff_{—}abs[i][j][l] | u(6) |
| interp_{—}filter_{—}coeff_{—}sign[i][j][l] | u(1) |

}

}

}

}

}

In such an embodiment, an exemplary syntax element “arbitrary_interp_filter_used_flag” (an example of which is highlighted in bold in Table 10, but which may take any form, label, terminology, or combination thereof, all of which are contemplated as within the scope of the instant disclosure) may specify whether an arbitrary interpolation filter is present. When exemplary syntax element arbitrary_interp_filter_used_flag is set to 1, arbitrary interpolation filters may be used for the interpolation process.

Again, in such an embodiment, an exemplary syntax element “num_interp_filter_set” (an example of which is highlighted in bold in Table 10, but which may take any form, label, terminology, or combination thereof, all of which are contemplated as within the scope of the instant disclosure), or its equivalent, may specify a number of interpolation filter sets presented in the bit-stream.

Yet again, in such an embodiment, an exemplary syntax element “interp_filter_coeff_shifting” (an example of which is highlighted in bold in Table 10, but which may take any form, label, terminology, or combination thereof, all of which are contemplated as within the scope of the instant disclosure), or its equivalent, may specify a number of right shift operations used for pixel interpolation.

And yet again, in such an embodiment, an exemplary syntax element “num_interp_filter[i]” (an example of which is highlighted in bold in Table 10, but which may take any form, label, terminology, or combination thereof, all of which are contemplated as within the scope of the instant disclosure), or its equivalent, may specify a number of interpolation filters in the i-th interpolation filter set.

Here again, in such an embodiment, an exemplary syntax element “num_interp_filter_coefff[i]” (an example of which is highlighted in bold in Table 10, but which may take any form, label, terminology, or combination thereof, all of which are contemplated as within the scope of the instant disclosure), or its equivalent, may specify a number of taps used for the interpolation filters in the i-th interpolation filter set.

Here again, in such an embodiment, an exemplary syntax element “interp_filter_coeff_abs[i][j][1]” (an example of which is highlighted in bold in Table 10, but which may take any form, label, terminology, or combination thereof, all of which are contemplated as within the scope of the instant disclosure), or its equivalent, may specify an absolute value of the 1-th coefficient of the j-th interpolation filter in the i-th interpolation filter set.

And yet again, in such an embodiment, an exemplary syntax element “interp_filter_coeff_sign[i][j][1]” (an example of which is highlighted in bold in Table 10, but which may take any form, label, terminology, or combination thereof, all of which are contemplated as within the scope of the instant disclosure), or its equivalent, may specify a sign of the 1-th coefficient of the j-th interpolation filter in the i-th interpolation filter set.

The disclosed syntax elements may be indicated in any high-level parameter set such as VPS, SPS, PPS, and a slice segment header. Note also that additional syntax elements may be used at a sequence level, picture level, and/or CU-level to facilitate the selection of interpolation filters for an operational coding level. Also note that the disclosed flags may be replaced by variables that may indicate a selected filter set. Note that in the contemplated embodiments, any number (e.g., two, three, or more) of sets of interpolation filters may be signaled in a bitstream.

Using the disclosed embodiments, arbitrary combinations of interpolation filters may be used to interpolate pixels at fractional positions during a motion compensated prediction process. For example, in an embodiment, where lossy coding of 4:4:4 video signals (in a format of RGB or YCbCr) may be performed, default 8-tap filters may be used to generate fractional pixels for the three color components (i.e., the R, G, and B components). In another embodiment, where the lossless coding of video signals may be performed, default 4-tap filters may be used to generate fractional pixels for the three color components (i.e., the Y, Cb, and Cr components in YCbCr color space, and R, G, and B components in RGB color space).

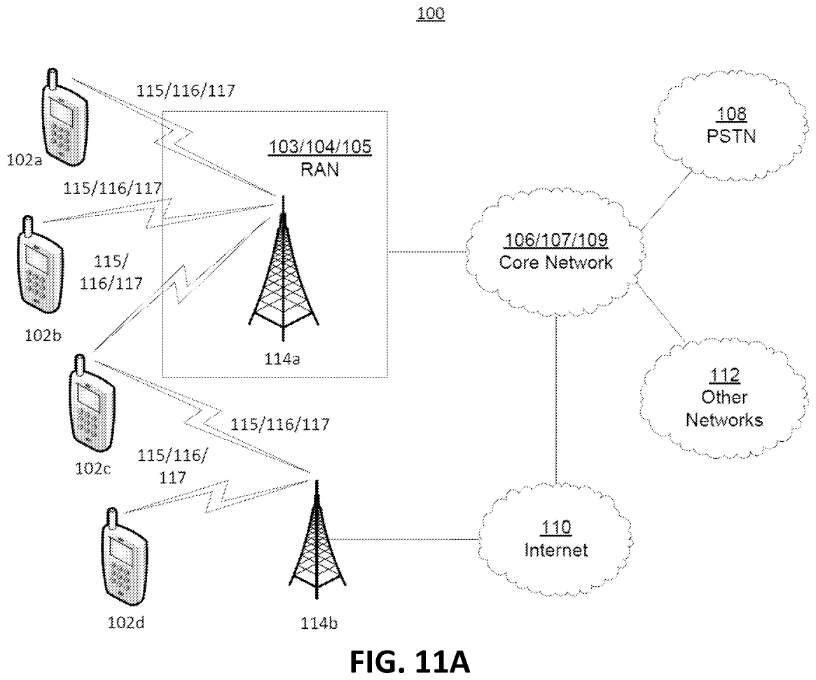

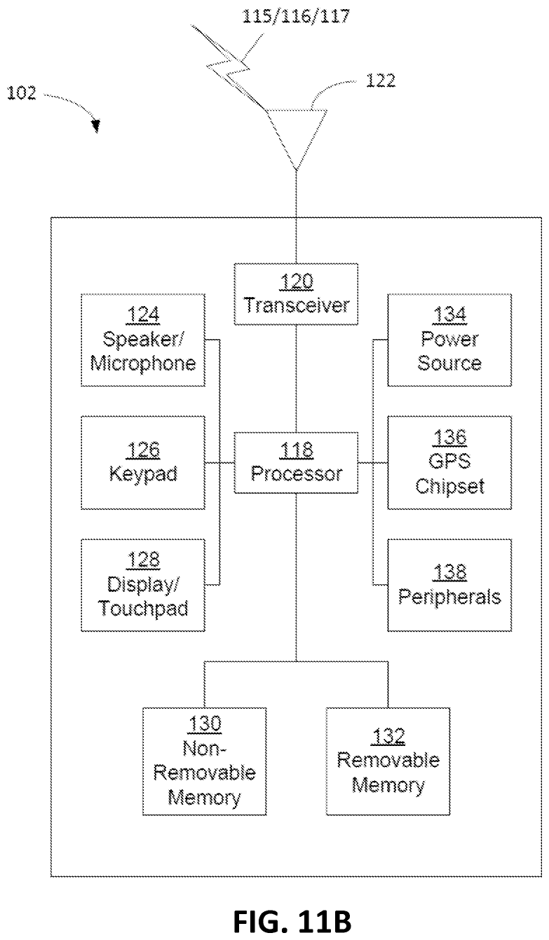

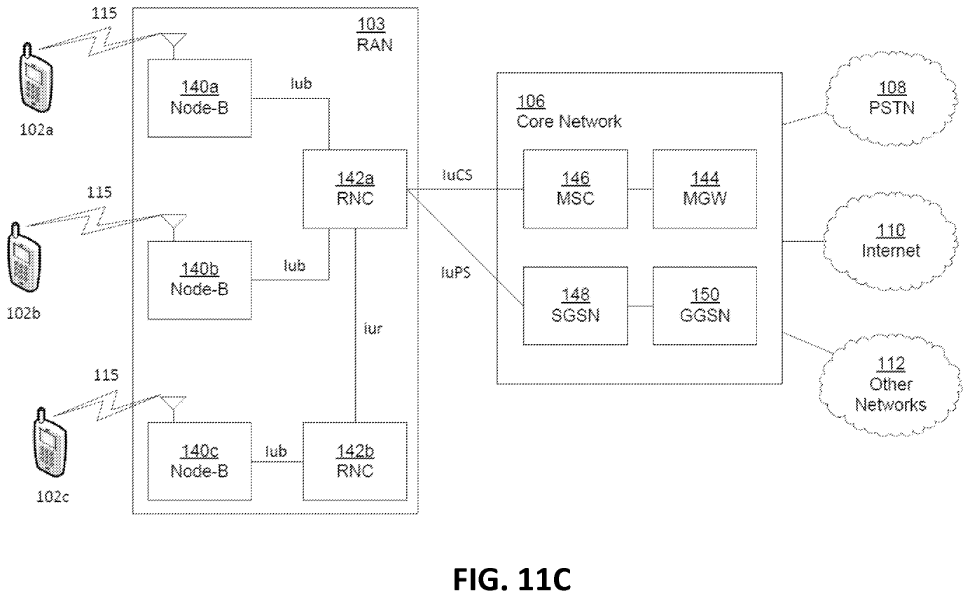

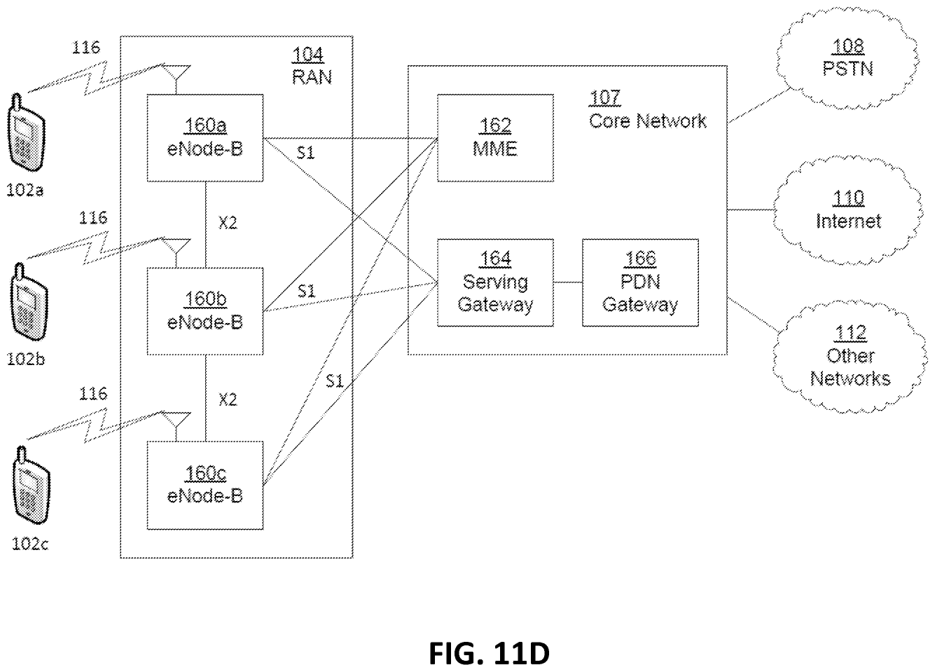

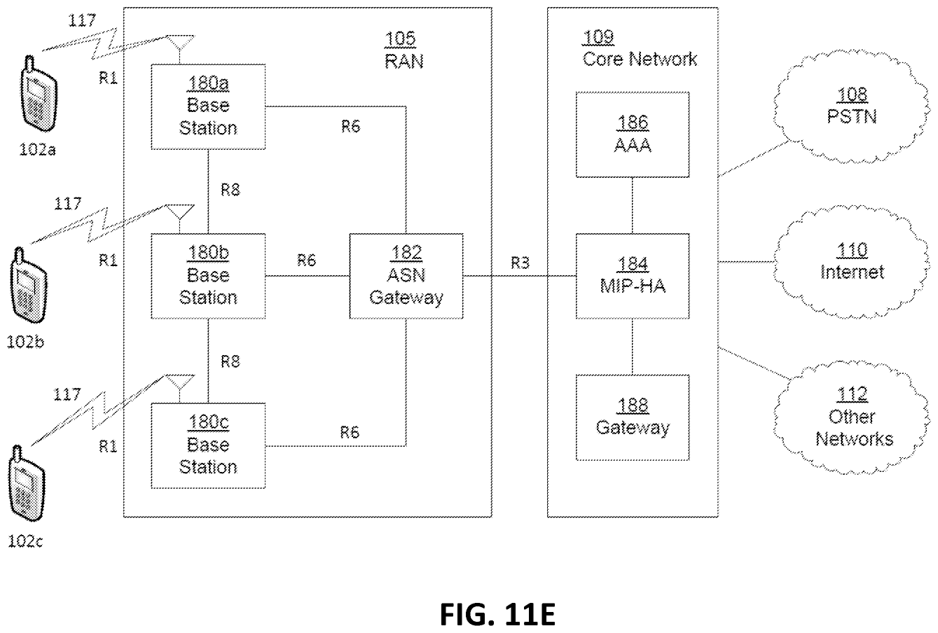

FIG. 11A is a diagram of an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single carrier FDMA (SC-FDMA), and the like.

As shown in FIG. 11A, the communications system 100 may include wireless transmit/receive units (WTRUs) 102a, 102b, 102c, and/or 102d (which generally or collectively may be referred to as WTRU 102), a radio access network (RAN) 103/104/105, a core network 106/107/109, a public switched telephone network (PSTN) 108, the Internet 110, and other networks 112, though it will be appreciated that the disclosed systems and methods contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d may be configured to transmit and/or receive wireless signals and may include user equipment (UE), a mobile station, a fixed or mobile subscriber unit, a pager, a cellular telephone, a personal digital assistant (PDA), a smartphone, a laptop, a netbook, a personal computer, a wireless sensor, consumer electronics, and the like.

The communications systems 100 may also include a base station 114a and a base station 114b. Each of the base stations 114a, 114b may be any type of device configured to wirelessly interface with at least one of the WTRUs 102a, 102b, 102c, 102d to facilitate access to one or more communication networks, such as the core network 106/107/109, the Internet 110, and/or the networks 112. By way of example, the base stations 114a, 114b may be a base transceiver station (BTS), a Node-B, an eNode B, a Home Node B, a Home eNode B, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 103/104/105, which may also include other base stations and/or network elements (not shown), such as a base station controller (BSC), a radio network controller (RNC), relay nodes, etc. The base station 114a and/or the base station 114b may be configured to transmit and/or receive wireless signals within a particular geographic region, which may be referred to as a cell (not shown). The cell may further be divided into cell sectors. For example, the cell associated with the base station 114a may be divided into three sectors. Thus, in one embodiment, the base station 114a may include three transceivers, e.g., one for each sector of the cell. In another embodiment, the base station 114a may employ multiple-input multiple output (MIMO) technology and, therefore, may utilize multiple transceivers for each sector of the cell.

The base stations 114a, 114b may communicate with one or more of the WTRUs 102a, 102b, 102c, 102d over an air interface 115/116/117, which may be any suitable wireless communication link (e.g., radio frequency (RF), microwave, infrared (IR), ultraviolet (UV), visible light, etc.). The air interface 115/116/117 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 103/104/105 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In another embodiment, the base station 114a and the WTRUs 102a, 102b, 102c may implement a radio technology such as Evolved UMTS Terrestrial Radio Access (E-UTRA), which may establish the air interface 115/116/117 using Long Term Evolution (LTE) and/or LTE-Advanced (LTE-A).

In other embodiments, the base station 114a and the WTRUs 102a, 102b, 102c may implement radio technologies such as IEEE 802.16 (e.g., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like. The base station 114b in FIG. 11A may be a wireless router, Home Node B, Home eNode B, or access point, for example, and may utilize any suitable RAT for facilitating wireless connectivity in a localized area, such as a place of business, a home, a vehicle, a campus, and the like. In one embodiment, the base station 114b and the WTRUs 102c, 102d may implement a radio technology such as IEEE 802.11 to establish a wireless local area network (WLAN). In another embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, etc.) to establish a picocell or femtocell. As shown in FIG. 11A, the base station 114b may have a direct connection to the Internet 110. Thus, the base station 114b may not be required to access the Internet 110 via the core network 106/107/109.

The RAN 103/104/105 may be in communication with the core network 106/107/109 that may be any type of network configured to provide voice, data, applications, and/or voice over internet protocol (VoIP) services to one or more of the WTRUs 102a, 102b, 102c, 102d. For example, the core network 106/107/109 may provide call control, billing services, mobile location-based services, pre-paid calling, Internet connectivity, video distribution, etc., and/or perform high-level security functions, such as user authentication. Although not shown in FIG. 11A, it will be appreciated that the RAN 103/104/105 and/or the core network 106/107/109 may be in direct or indirect communication with other RANs that employ the same RAT as the RAN 103/104/105 or a different RAT. For example, in addition to being connected to the RAN 103/104/105, which may be utilizing an E-UTRA radio technology, the core network 106/107/109 may also be in communication with another RAN (not shown) employing a GSM radio technology.

The core network 106/107/109 may also serve as a gateway for the WTRUs 102a, 102b, 102c, 102d to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and the internet protocol (IP) in the TCP/IP internet protocol suite. The networks 112 may include wired or wireless communications networks owned and/or operated by other service providers. For example, the networks 112 may include another core network connected to one or more RANs, which may employ the same RAT as the RAN 103/104/105 or a different RAT.

Some or all of the WTRUs 102a, 102b, 102c, 102d in the communications system 100 may include multi-mode capabilities, e.g., the WTRUs 102a, 102b, 102c, 102d may include multiple transceivers for communicating with different wireless networks over different wireless links. For example, the WTRU 102c shown in FIG. 11A may be configured to communicate with the base station 114a, which may employ a cellular-based radio technology, and with the base station 114b, which may employ an IEEE 802 radio technology.

FIG. 11B is a system diagram of an example WTRU 102. As shown in FIG. 11B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and other peripherals 138. It will be appreciated that the WTRU 102 may include any subcombination of the foregoing elements while remaining consistent with an embodiment. Also, embodiments contemplate that the base stations 114a and 114b, and/or the nodes that base stations 114a and 114b may represent, such as but not limited to transceiver station (BTS), a Node-B, a site controller, an access point (AP), a home node-B, an evolved home node-B (eNodeB), a home evolved node-B (HeNB), a home evolved node-B gateway, and proxy nodes, among others, may include some or all of the elements depicted in FIG. 11B and described herein.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 11B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 115/116/117. For example, in one embodiment, the transmit/receive element 122 may be an antenna configured to transmit and/or receive RF signals. In another embodiment, the transmit/receive element 122 may be an emitter/detector configured to transmit and/or receive IR, UV, or visible light signals, for example. In yet another embodiment, the transmit/receive element 122 may be configured to transmit and receive both RF and light signals. It will be appreciated that the transmit/receive element 122 may be configured to transmit and/or receive any combination of wireless signals.

In addition, although the transmit/receive element 122 is depicted in FIG. 11B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 115/116/117.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as UTRA and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 115/116/117 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138 that may include one or more software and/or hardware modules that provide additional features, functionality, and/or wired or wireless connectivity. For example, the peripherals 138 may include an accelerometer, an e-compass, a satellite transceiver, a digital camera (for photographs or video), a universal serial bus (USB) port, a vibration device, a television transceiver, a hands free headset, a Bluetooth® module, a frequency modulated (FM) radio unit, a digital music player, a media player, a video game player module, an Internet browser, and the like.

FIG. 11C is a system diagram of the RAN 103 and the core network 106 according to an embodiment. As noted above, the RAN 103 may employ a UTRA radio technology to communicate with the WTRUs 102a, 102b, 102c over the air interface 115. The RAN 103 may also be in communication with the core network 106. As shown in FIG. 11C, the RAN 103 may include Node-Bs 140a, 140b, 140c, which may each include one or more transceivers for communicating with the WTRUs 102a, 102b, 102c over the air interface 115. The Node-Bs 140a, 140b, 140c may each be associated with a particular cell (not shown) within the RAN 103. The RAN 103 may also include RNCs 142a, 142b. It will be appreciated that the RAN 103 may include any number of Node-Bs and RNCs while remaining consistent with an embodiment.

As shown in FIG. 11C, the Node-Bs 140a, 140b may be in communication with the RNC 142a. Additionally, the Node-B 140c may be in communication with the RNC142b. The Node-Bs 140a, 140b, 140c may communicate with the respective RNCs 142a, 142b via an Iub interface. The RNCs 142a, 142b may be in communication with one another via an Iur interface. Each of the RNCs 142a, 142b may be configured to control the respective Node-Bs 140a, 140b, 140c to which it is connected. In addition, each of the RNCs 142a, 142b may be configured to carry out or support other functionality, such as outer loop power control, load control, admission control, packet scheduling, handover control, macrodiversity, security functions, data encryption, and the like.

The core network 106 shown in FIG. 11C may include a media gateway (MGW) 144, a mobile switching center (MSC) 146, a serving GPRS support node (SGSN) 148, and/or a gateway GPRS support node (GGSN) 150. While each of the foregoing elements are depicted as part of the core network 106, it will be appreciated that any one of these elements may be owned and/or operated by an entity other than the core network operator.

The RNC 142a in the RAN 103 may be connected to the MSC 146 in the core network 106 via an IuCS interface. The MSC 146 may be connected to the MGW 144. The MSC 146 and the MGW 144 may provide the WTRUs 102a, 102b, 102c with access to circuit-switched networks, such as the PSTN 108, to facilitate communications between the WTRUs 102a, 102b, 102c and traditional land-line communications devices.

The RNC 142a in the RAN 103 may also be connected to the SGSN 148 in the core network 106 via an IuPS interface. The SGSN 148 may be connected to the GGSN 150. The SGSN 148 and the GGSN 150 may provide the WTRUs 102a, 102b, 102c with access to packet-switched networks, such as the Internet 110, to facilitate communications between and the WTRUs 102a, 102b, 102c and IP-enabled devices.

As noted above, the core network 106 may also be connected to the networks 112 that may include other wired or wireless networks that are owned and/or operated by other service providers.

FIG. 11D is a system diagram of the RAN 104 and the core network 107 according to an embodiment. As noted above, the RAN 104 may employ an E-UTRA radio technology to communicate with the WTRUs 102a, 102b, 102c over the air interface 116. The RAN 104 may also be in communication with the core network 107.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and receive wireless signals from, the WTRU 102a.

Each of the eNode-Bs 160a, 160b, 160c may be associated with a particular cell (not shown) and may be configured to handle radio resource management decisions, handover decisions, scheduling of users in the uplink and/or downlink, and the like. As shown in FIG. 11D, the eNode-Bs 160a, 160b, 160c may communicate with one another over an X2 interface.

The core network 107 shown in FIG. 11D may include a mobility management gateway (MME) 162, a serving gateway 164, and a packet data network (PDN) gateway 166. While each of the foregoing elements are depicted as part of the core network 107, it will be appreciated that any one of these elements may be owned and/or operated by an entity other than the core network operator.

The MME 162 may be connected to each of the eNode-Bs 160a, 160b, 160c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may also provide a control plane function for switching between the RAN 104 and other RANs (not shown) that employ other radio technologies, such as GSM or WCDMA.

The serving gateway 164 may be connected to each of the eNode-Bs 160a, 160b, 160c in the RAN 104 via the S1 interface. The serving gateway 164 may generally route and forward user data packets to/from the WTRUs 102a, 102b, 102c. The serving gateway 164 may also perform other functions, such as anchoring user planes during inter-eNode B handovers, triggering paging when downlink data is available for the WTRUs 102a, 102b, 102c, managing and storing contexts of the WTRUs 102a, 102b, 102c, and the like.

The serving gateway 164 may also be connected to the PDN gateway 166 that may provide the WTRUs 102a, 102b, 102c with access to packet-switched networks, such as the Internet 110, to facilitate communications between the WTRUs 102a, 102b, 102c and IP-enabled devices.

The core network 107 may facilitate communications with other networks. For example, the core network 107 may provide the WTRUs 102a, 102b, 102c with access to circuit-switched networks, such as the PSTN 108, to facilitate communications between the WTRUs 102a, 102b, 102c and traditional land-line communications devices. For example, the core network 107 may include, or may communicate with, an IP gateway (e.g., an IP multimedia subsystem (IMS) server) that serves as an interface between the core network 107 and the PSTN 108. In addition, the core network 107 may provide the WTRUs 102a, 102b, 102c with access to the networks 112, which may include other wired or wireless networks that are owned and/or operated by other service providers.

FIG. 11E is a system diagram of the RAN 105 and the core network 109 according to an embodiment. The RAN 105 may be an access service network (ASN) that employs IEEE 802.16 radio technology to communicate with the WTRUs 102a, 102b, 102c over the air interface 117. As will be further discussed below, the communication links between the different functional entities of the WTRUs 102a, 102b, 102c, the RAN 105, and the core network 109 may be defined as reference points.

As shown in FIG. 11E, the RAN 105 may include base stations 180a, 180b, 180c, and an ASN gateway 182, though it will be appreciated that the RAN 105 may include any number of base stations and ASN gateways while remaining consistent with an embodiment. The base stations 180a, 180b, 180c may each be associated with a particular cell (not shown) in the RAN 105 and may each include one or more transceivers for communicating with the WTRUs 102a, 102b, 102c over the air interface 117. In one embodiment, the base stations 180a, 180b, 180c may implement MIMO technology. Thus, the base station 180a, for example, may use multiple antennas to transmit wireless signals to, and receive wireless signals from, the WTRU 102a. The base stations 180a, 180b, 180c may also provide mobility management functions, such as handoff triggering, tunnel establishment, radio resource management, traffic classification, quality of service (QoS) policy enforcement, and the like. The ASN gateway 182 may serve as a traffic aggregation point and may be responsible for paging, caching of subscriber profiles, routing to the core network 109, and the like.

The air interface 117 between the WTRUs 102a, 102b, 102c and the RAN 105 may be defined as an R1 reference point that implements the IEEE 802.16 specification. In addition, each of the WTRUs 102a, 102b, 102c may establish a logical interface (not shown) with the core network 109. The logical interface between the WTRUs 102a, 102b, 102c and the core network 109 may be defined as an R2 reference point, which may be used for authentication, authorization, IP host configuration management, and/or mobility management.

The communication link between each of the base stations 180a, 180b, 180c may be defined as an R8 reference point that includes protocols for facilitating WTRU handovers and the transfer of data between base stations. The communication link between the base stations 180a, 180b, 180c and the ASN gateway 182 may be defined as an R6 reference point. The R6 reference point may include protocols for facilitating mobility management based on mobility events associated with each of the WTRUs 102a, 102b, 102c.

As shown in FIG. 11E, the RAN 105 may be connected to the core network 109. The communication link between the RAN 105 and the core network 109 may defined as an R3 reference point that includes protocols for facilitating data transfer and mobility management capabilities, for example. The core network 109 may include a mobile IP home agent (MIP-HA) 184, an authentication, authorization, accounting (AAA) server 186, and a gateway 188. While each of the foregoing elements are depicted as part of the core network 109, it will be appreciated that any one of these elements may be owned and/or operated by an entity other than the core network operator.

The MIP-HA may be responsible for IP address management, and may enable the WTRUs 102a, 102b, 102c to roam between different ASNs and/or different core networks. The MIP-HA 184 may provide the WTRUs 102a, 102b, 102c with access to packet-switched networks, such as the Internet 110, to facilitate communications between the WTRUs 102a, 102b, 102c and IP-enabled devices. The AAA server 186 may be responsible for user authentication and for supporting user services. The gateway 188 may facilitate interworking with other networks. For example, the gateway 188 may provide the WTRUs 102a, 102b, 102c with access to circuit-switched networks, such as the PSTN 108, to facilitate communications between the WTRUs 102a, 102b, 102c and traditional land-line communications devices. In addition, the gateway 188 may provide the WTRUs 102a, 102b, 102c with access to the networks 112, which may include other wired or wireless networks that are owned and/or operated by other service providers.

Although not shown in FIG. 11E, it will be appreciated that the RAN 105 may be connected to other ASNs and the core network 109 may be connected to other core networks. The communication link between the RAN 105 the other ASNs may be defined as an R4 reference point, which may include protocols for coordinating the mobility of the WTRUs 102a, 102b, 102c between the RAN 105 and the other ASNs. The communication link between the core network 109 and the other core networks may be defined as an R5 reference, which may include protocols for facilitating interworking between home core networks and visited core networks.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

1-20. (canceled)

21. A method for decoding video content, the method comprising:
obtaining a current block for performing color space transform;
determining whether the current block is lossy coded or lossless coded;
selecting a conversion, from a plurality of color space transform conversions, based on whether the current block is lossy coded or lossless coded; and
performing color space transform on the current block using the selected conversion.

22. The method claim 21, wherein a first conversion is selected on a condition that the current block is lossy coded, and a second conversion is selected on a condition that the current block is lossless coded, the second conversion being different than the first conversion.

23. The method claim 21, wherein a first conversion is selected on a condition that the current block is lossy coded, and a second conversion is selected on a condition that the current block is lossless coded, the second conversion being associated with a different conversion matrix from the conversion matrix associated with the first conversion.

24. The method claim 21, wherein based on a determination that the current block is lossy coded, an irreversible conversion is selected for color space transform.

25. The method claim 21, wherein based on a determination that the current block is lossless coded, a reversible conversion is selected for color space transform.

26. The method claim 21, wherein a first conversion associated with an irreversible conversion matrix is selected on a condition that the current block is lossy coded, and a second conversion with a reversible conversion matrix is selected on a condition that the current block is lossless coded.

27. A decoding device for decoding video content, the decoding device comprises at least one processor configured to:
obtain a current block for performing color space transform;
determine whether the current block is lossy coded or lossless coded;
select a conversion, from a plurality of color space transform conversions, based on whether the current block is lossy coded or lossless coded; and
perform color space transform on the current block using the selected conversion.

28. The decoding device of claim 27, wherein a first conversion is selected on a condition that the current block is lossy coded, and a second conversion is selected on a condition that the current block is lossless coded, the second conversion being different than the first conversion.

29. The decoding device of claim 27, wherein a first conversion is selected on a condition that the current block is lossy coded, and a second conversion is selected on a condition that the current block is lossless coded, the second conversion being associated with a different conversion matrix from the conversion matrix associated with the first conversion.

30. The decoding device of claim 27, wherein based on a determination that the current block is lossy coded, an irreversible conversion is selected for color space transform.

31. The decoding device of claim 27, wherein based on a determination that the current block is lossless coded, a reversible conversion is selected for color space transform.

32. The decoding device of claim 27, wherein a first conversion associated with an irreversible conversion matrix is selected on a condition that the current block is lossy coded, and a second conversion with a reversible conversion matrix is selected on a condition that the current block is lossless coded.

33. A method for encoding video content, the method comprising:
determining to perform color space transform on a current block;
determining whether the current block is to be lossy coded or lossless coded;
selecting a conversion, from a plurality of color space transform conversions, based on whether the current block is to be lossy coded or lossless coded; and
performing color space transform on the current block using the selected conversion.

34. The method claim 33, wherein based on a determination that the current block is to be lossy coded, an irreversible conversion is selected for color space transform, and based on a determination that the current block is to be lossless coded, a reversible conversion is selected for color space transform.

35. The method claim 33, wherein a first conversion associated with an irreversible conversion matrix is selected on a condition that the current block is to be lossy coded, and a second conversion with a reversible conversion matrix is selected on a condition that the current block is to be lossless coded.

36. A encoding device for encoding video content, the encoding device comprises at least one processor configured to:
determine to perform color space transform on a current block;
determine whether the current block is to be lossy coded or lossless coded;
select a conversion, from a plurality of color space transform conversions, based on whether the current block is to be lossy coded or lossless coded; and
perform color space transform on the current block using the selected conversion.

37. The encoding device of claim 36, wherein based on a determination that the current block is to be lossy coded, an irreversible conversion is selected for color space transform, and based on a determination that the current block is to be lossless coded, a reversible conversion is selected for color space transform.

38. The encoding device of claim 36, wherein a first conversion associated with an irreversible conversion matrix is selected on a condition that the current block is to be lossy coded, and a second conversion with a reversible conversion matrix is selected on a condition that the current block is to be lossless coded.
